(19) United States
(12) Patent Application Publication
(10) Pub. No.: US 2002/0018271 A1
(43) Pub. Date: Feb. 14, 2002

(54) Automatic intermediate frequency stabilization control in optical signal transmission system

(75) Inventor: Sachiko Takeuchi, Yokohama-shi (JP)

Correspondence Address: Connolly Bove Lodge & Hutz LLP, Suite 800, 1990 M Street, N.W., Washington, DC, 20036-3425, US

(73) Assignee: Matsushita Electric Industrial Co., Ltd., Osaka (JP)

(21) Appl. No.: 09/923,331

(22) Filed: Aug. 8, 2001

(30) Foreign Application Priority Data
Aug. 8, 2000 (JP) 2000-240408
Aug. 9, 2000 (JP) 2000-240901
Sep. 29, 2000 (JP) 2000-300815

(51) Int. Cl. H04B 10/04; H04B 10/06

(52) U.S. Cl. 359/187; 359/191

(57) ABSTRACT

In response to detecting an intermediate frequency signal whose frequency deviates from a specified range of frequencies, the intermediate frequency signal is pulled into a stable operation point for the automatic intermediate frequency stabilization control. This prevents erroneous operations in frequency discrimination, leading to automatic intermediate frequency stabilization control carried out steadily. In the pulling control, the stable operation point is determined based on an output frequency from a frequency discriminator and its primary and secondary differential values to temperature or bias current of a laser, and then the intermediate frequency signal is pulled into the stable operation point. In addition, where the intermediate frequency signal deviates from its stabilized control state, oscillation frequencies of FM laser and/or local oscillating laser are controlled based on previously memorized their bias current and/or temperature to restart stabilization control of the intermediate frequency signal.

### BACKGROUND OF THE INVENTION

1. Field of the Invention

The present invention relates to automatic intermediate frequency stabilization control in a transmitter or receiver to transmit or receive optical signals in an optical signal transmission system that uses an optical heterodyne detection technique.

2. Description of Related Art

In an optical signal transmission system using an optical heterodyne detection technique, there are provided a transmitter for transmitting optical signals and a receiver for receiving optical signals. In such transmitter and receiver, an optical signal is combined between outputs from an optical-frequency-modulated laser beam (FM laser beam) and a local oscillating laser beam (LO laser beam), and then detected by an optical detector to produce a beat signal (i.e., intermediate frequency signal). The beat signal corresponds to a difference in frequency between both the laser beams. In the transmitter, the beat signal is again optically modulated before being transmitted. Meanwhile, in the receiver, the beat signal is subject to demodulation to be produced into a base band signal. If the FM laser beam and/or LO laser beam fluctuate in frequency in such an optical signal transmission system, the resultant intermediate frequency signal also fluctuates. When such fluctuations occur, the transmission characteristic or reception characteristic deteriorates. This is why automatic stabilization control for the intermediate frequency signal (automatic frequency control: AFC) is required.

The intermediate frequency signal is divided into a real region or an imaginary region depending on whether the FM laser beam is higher or lower in frequency than the LO laser beam. The characteristic of input/output frequencies of a frequency discriminator used for the AFC is opposite to each other between the real and imaginary regions. The AFC is performed by adjusting the bias current and/or temperature of the optical-frequency-modulated laser and/or local oscillating laser. In such AFC, if the operation point for the AFC is set to a certain location within the real region regardless of the fact that the intermediate frequency signal lies in the imaginary region, the AFC will no longer operates.

To overcome this problem, a technique of determining the real and imaginary regions from each other has frequently been used. That is, with an intermediate frequency signal inputted to the frequency discriminator, the oscillation frequency of an FM laser beam or LO laser beam is subject to its sweep, during which time rates of changes in output frequencies of the frequency discriminator to the swept frequency are obtained. Depending on the fact that the change rate is positive or negative, it is determined that the intermediate frequency signal is in the real region or the imaginary region.

However, using this technique should take into account that the output frequency of the frequency discriminator depends on its input frequency. To be specific, when a stable operation point for the AFC resides, for example, at a certain location in the real region, the same polarity of a change rate in the output frequency of the frequency discriminator to the swept input frequency and the same output frequency as those of the certain location are present at a further location in the imaginary region, the further location being identical to the foregoing certain location in the real region. As to classifying locations at each of which an operation point exists, there have been proposed a variety of techniques.

Japanese Patent Laid-open publication No. 5-227093 discloses one such technique. By this technique, an oscillation frequency of an LO laser beam source is swept, during which time an intermediate frequency is pulled into a stable operation point for the AFC. Practically, as an intermediate frequency signal is inputted into a frequency discriminator and bias current or temperature of a semiconductor laser is swept, a rate of changes in the output voltage of the frequency discriminator is measured. The width of a first region in which the change rate is higher than a first threshold (a swept width of the bias current or temperature) and that of a second region in which the change rate, which appears immediately before or after the first region, is lower than a second threshold are mutually compared with each other. In cases the first region (or second one) is larger than the second region (or first one) over a certain rate, the intermediate frequency signal is pulled into the first region (or second one).

However, such conventional automatic frequency stabilization control circuit has various problems that have been unsolved.

A first problem is that such circuitry elements as the frequency discriminator and filter are different element by element, so different circuits need different thresholds. If the threshold differs in value, the operation of the AFC necessarily becomes unstable, which requires each system to be adjusted independently. Further, a circuit to adjust the threshold is additionally required, which results in a large-sized and/or complicated-structure control circuit.

A second problem is that, in the case of the AFC procedures described above, the frequency may fluctuate sharply at its stable operation point during the control so that the operation point deviates largely from its stabilized operation range. If such a case happens, the AFC will be no longer effective.

To overcome this second problem, there has been known a technique disclosed by Japanese Patent Laid-open 5-308325. According to the technique, when an input FM laser beam is temporarily interrupted, a timing extraction circuit detects a situation in which a clock component extracted from the base band signal becomes smaller than a certain amount, and outputs an alarm signal. An LO laser beam source control circuit which has received the alarm signal reads out, from a memory, temperature or bias current corresponding to a frequency of the LO laser beam source immediacy before the detection of the alarm signal. Then, the control circuit controls the frequency of the LO laser beam source to the read-out value. This makes it possible that the LO laser beam source is immediately subject to a stable frequency control if the FM laser beam is again inputted.

However, this countermeasure is based on the technique that an interruption of the input is detected to provide the laser with a frequency shown immediately before the input interruption. Therefore, if the operation point moves into the imaginary region due to sharp fluctuations in the frequency without any interruption of the input, there is a problem that such situation cannot be detected. In addition, if there is no such interruption of the input signal, it is difficult to specify a timing at which information about temperature or bias current should be memorized in a memory, thus giving rise to complicated design of the circuit.

### SUMMARY OF THE INVENTION

The present invention has been made to overcome the above problems. A first object of the present invention is to provide an automatic intermediate frequency stabilization control apparatus and a control method thereof that are able to accurately determine a stable operation point for automatic intermediate frequency stabilization control so that an intermediate frequency is pulled into its stable operation point, in no dependency on differences in individual electric circuitry elements, such as a frequency discriminator and a filter.

A second object of the present invention is to provide an automatic intermediate frequency stabilization control apparatus and a control method thereof, of which operation are stable, that are capable of restarting a normal automatic frequency control in a shorter time by detecting, without fail, a situation where an intermediate frequency is brought into its imaginary region on account of its sharp fluctuations.

In order to accomplish the first object, according to one embodiment of the present invention, an automatic intermediate frequency stabilization control apparatus comprises intermediate frequency signal producing means for producing an intermediate frequency signal by combining light outputted from an FM laser with light outputted from a local oscillating laser and performing heterodyne detection with combined light, a difference between both oscillation frequencies of the light outputs corresponding to the intermediate frequency signal; frequency discrimination means for discriminating in frequency the intermediate frequency signal for automatic intermediate frequency stabilization control; detecting means for detecting a given state in which the intermediate frequency signal is over in frequency than a specified frequency; and pulling control means for pulling the intermediate frequency signal into a stable operation point for the automatic intermediate frequency stabilization control when the detecting means detect the given state.

Preferably, the frequency discrimination means has a frequency counter receiving the intermediate frequency signal and the detecting means has overflow detecting means for outputting an overflow signal when a count of the frequency counter reaches the specified frequency.

Accordingly, with no erroneous operation in a frequency band higher than that of circuitry elements located before the frequency discriminator, the intermediate frequency can steadily be pulled into a stable operation point for automatic stabilization control.

Preferably, the apparatus may further comprises an electric coupler to make a path of the intermediate frequency signal to a plurality of paths thereof and a prescaler to divide the intermediate frequency signal received through one of the paths up to an operation frequency of the frequency counter, wherein the overflow detecting means is configured so as to output the overflow signal in cases the intermediate frequency signal reaches a frequency indicative of an outside frequency band higher than a frequency band of electric circuitry constituents located before the prescaler, the frequency corresponding to the given frequency.

Still preferably, the frequency discrimination means has a frequency counter receiving the intermediate frequency signal and holding a count corresponding to the given frequency when the intermediate frequency signal is over the given frequency and the detecting means detect the given state when the frequency counter holds the count thereof. As a result, the configuration to pull the intermediate frequency to the stable operation point can be simplified.

Still, as another preferred configuration, there may be provided determining means for determining a stable operation point for the automatic intermediate frequency stabilization control on the basis of a frequency of an output signal of the frequency discrimination means and primary and secondary differential values of the output signal frequency to either of bias current and temperature of at least one of the lasers; and controlling means for pulling the intermediate frequency signal into the stable operation point determined by the determining means.

Accordingly, a stable operation point for automatic stabilization control of the intermediate frequency signal can be determined almost without fail, thus removing erroneous operation points existing outside the frequency band of the frequency discriminator. Therefore, the intermediate frequency can be pulled into its stable operation point for certainty.

For example, the determining means is configured so as to determine, as the stable operation point, a point of frequency satisfying a condition that the output signal frequency of the frequency discrimination means is at a target frequency, the primary differential value is within a predetermined range, and the secondary differential value is approximately zero. In addition, the determining means may be configured so as to determine, as the stable operation point, a point of frequency satisfying a condition that the output signal frequency of the frequency discrimination means is at a target frequency, the primary differential value is either positive or negative, and the secondary differential value is approximately zero.

Further, in order to accomplish the second object, according to another example of the present invention, provided is an automatic intermediate frequency stabilization control apparatus comprising: intermediate frequency signal producing means for producing an intermediate frequency signal by combining light outputted from an FM laser with light outputted from a local oscillating laser and performing heterodyne detection with combined light, a difference between both oscillation frequencies of the light outputs corresponding to the intermediate frequency signal; memorizing means for memorizing data of at least one of bias current and temperature of at least one of the FM laser and the local oscillating laser when a stabilized control state of the intermediate frequency signal continues for a certain time; and restart control means for restart stabilized control of the intermediate frequency signal by controlling an oscillation signal of at least one of the FM laser and the local oscillating laser on the basis of at least the bias current and the temperature memorized in cases the intermediate frequency signal deviates from the stabilized control state.

Accordingly, data of the bias current and/or temperature of the FM laser and/or local oscillating laser are memorized, when the stabilized control state of the intermediate frequency signal continues for a certain period of time. In cases the frequency happens to shift from its stabilized control state, automatic stabilization control is restarted using the already-memorized data of the bias current and/or temperature. When the intermediate frequency is forced to enter its imaginary region due to its sharp fluctuations with no interruption of the input signal, the normal automatic frequency control can be restarted in a shorter time.

For example, the stabilized control state of the intermediate frequency signal is a state in which a difference between the intermediate frequency and a target frequency is smaller than a given value.

Further, by way of example, the memorizing means is configured so as to update the memorized data at intervals during the stabilized control state of the intermediate frequency signal.

Still, for example, the restart control means is configured so as to restart the automatic stabilization control in cases the intermediate frequency signal deviates from the stabilized control state after continuation of the stabilized control state for a given period of time. The restart control means may have means for stopping the control unless the stabilized control state is obtained even when an action to start the automatic stabilization control is repeated a predetermined number of times. Further, the restart control means may have means for searching a stable operation point for the automatic stabilization control by sweeping either the bias current or the temperature using, as a central value for the sweep, data of either the bias current or the temperature memorized in the memorizing means in cases the intermediate frequency signal deviates from the stabilized control state. Further, the restart control means may have means for setting the bias current and/or temperature to their initial values, for waiting a certain period of time, and then for searching a stable operation point for the automatic stabilization control by sweeping either the bias current or the temperature using, as a central value for the sweep, data of either the bias current or the temperature unless the stable operation point is found even when the stabilization control is restarted.

Accordingly, in cases the intermediate frequency signal deviates from the real region, this deviation can be detected for certainty to restart the normal automatic frequency control. Erroneous detection of deviation from the stabilized control state can also be avoided. Even when a stabilized control state has not been realized, it can be avoided to repeat a restoration action endless. Further, in replay to fluctuated widths of the intermediate frequency, the normal automatic frequency control can quickly be restarted without fail.

In addition, according to the present invention, another configuration to restart the automatic frequency control without previously memorizing data of the bias current and/or temperature of a laser can be provided. A method of controlling stabilization of an intermediate frequency, which has the identical function to the above control apparatus, is also provided. More practical configurations and features of the present invention will be described by the description in the following embodiments and drawings.

### BRIEF DESCRIPTION OF THE DRAWINGS

In the attached drawings:

FIG. 1 is a block diagram showing the configuration of an optical signal transmitter of heterodyne detection type in which an automatic intermediate frequency stabilization control apparatus according to a first embodiment of the present invention is incorporated;

FIG. 2 is a graph showing a dependency of an output frequency of a prescaler to its input frequency, which is incorporated in the automatic intermediate frequency stabilization control apparatus;

FIG. 3 is a graph showing a dependency of an output frequency of a frequency counter to its input frequency, which is incorporated in the automatic intermediate frequency stabilization control apparatus;

FIG. 4 is a graph representing a dependency of the output frequency of the frequency counter to an output frequency of an optical receiver;

FIG. 5 is a block diagram showing the configuration of an optical signal transmitter of heterodyne detection type in which an automatic intermediate frequency stabilization control apparatus according to a second embodiment of the present invention is incorporated;

FIG. 6 is a graph representing dependency of an output frequency of a frequency counter to an output frequency of an optical receiver, which is incorporated in an automatic intermediate frequency stabilization control apparatus according to the second embodiment;

FIG. 7 illustrates determination processing of an operation point conducted in modifications of a third embodiment according to the present invention;

FIG. 8 is a block diagram showing the configuration of an optical signal transmitter to which an automatic intermediate frequency stabilization control apparatus according to a fourth embodiment of the present invention is applied;

FIG. 9 is a flowchart representing the procedures of automatic frequency stabilization control conducted in the fourth embodiment;

FIG. 10 shows a timing chart of the automatic frequency stabilization control conducted in the fourth embodiment;

FIG. 11 is a flowchart representing the procedures of automatic frequency stabilization control conducted in a fifth embodiment of the present invention;

FIG. 12 is a flowchart representing the procedures of automatic frequency stabilization control conducted in a sixth embodiment of the present invention;

FIG. 13 is a flowchart representing the procedures of automatic frequency stabilization control conducted in a seventh embodiment of the present invention;

FIG. 14 is a flowchart representing the procedures of automatic frequency stabilization control conducted in an eighth embodiment of the present invention;

FIG. 15 is a flowchart representing the procedures of automatic frequency stabilization control conducted in a ninth embodiment of the present invention;

FIG. 16 is a flowchart representing the procedures of automatic frequency stabilization control conducted in a tenth embodiment of the present invention;

FIG. 17 is a flowchart representing the procedures of automatic frequency stabilization control conducted in an eleventh embodiment of the present invention;

FIG. 18 is a flowchart representing the procedures of automatic frequency stabilization control conducted in a twelfth embodiment of the present invention;

FIG. 19 is a flowchart representing the procedures of automatic frequency stabilization control conducted in a thirteenth embodiment of the present invention; and

FIG. 20 is a block diagram showing the configuration of an optical signal receiver of heterodyne detection type in which an automatic intermediate frequency stabilization control apparatus according to the present invention is incorporated.

### DETAILED DESCRIPTION OF PREFERRED EMBODIMENTS

Referring now to the drawings, exemplary embodiments of the present invention will be described.

First embodiment

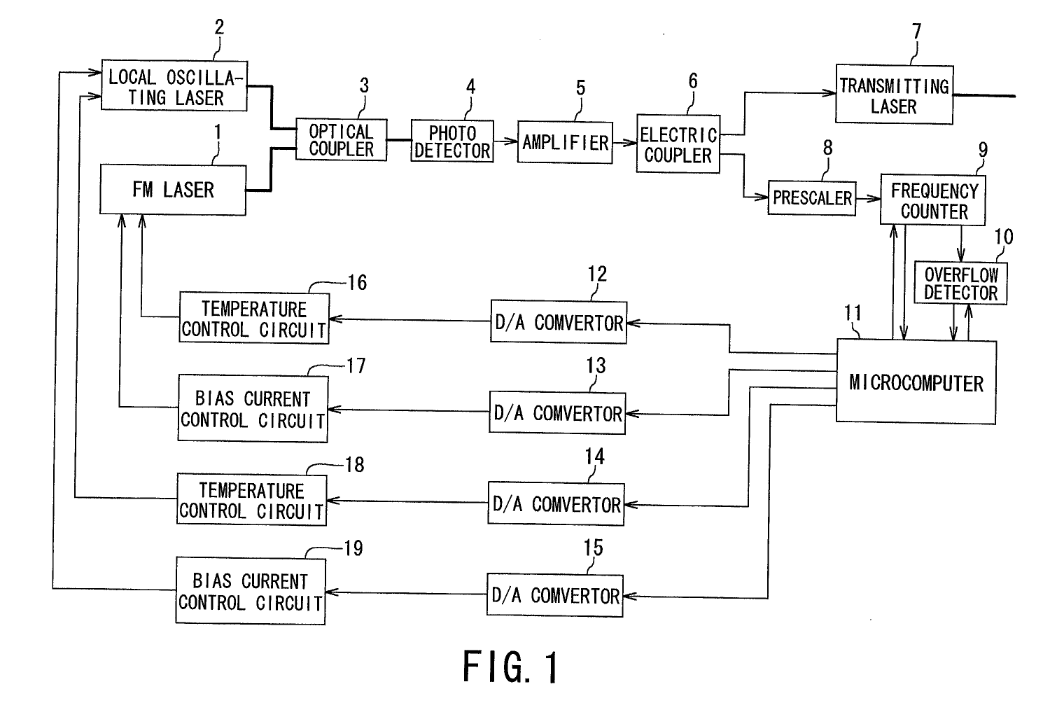

Referring to FIGS. 1 to 4, a first embodiment of the present invention will now be described.

FIG. 1 is a block diagram showing the configuration of an optical signal transmitter of heterodyne detection type to which an automatic intermediate frequency stabilization control apparatus according to a first embodiment of the present invention is applied. The optical signal transmitter is shown as a representative for an optical signal transmission system. In the figure, thick lines indicate optical paths.

The optical signal transmitter is provided with two lasers, that is, an FM laser 1 and a local oscillating laser 2. Light beams outputted from both the lasers 1 and 2 are combined by an optical coupler 3. The combined light of an intermediate frequency is supplied to an optical receiver 4 to undergo an optical-electric conversion, thus providing a beat signal. The beat signal is amplified by an amplifier 5, and then divided into two outputs by an electric coupler 6. One output is supplied to a transmitting laser 7, so that a signal is sent out again in the form of light. The other output from the electric coupler 6 is supplied to a prescaler 8.

The prescaler 8 is to divide the inputted intermediate frequency signal within a range of operation frequencies of a frequency counter 9 functioning as a frequency discriminator. The divided output signal is then inputted into the frequency counter 9. This frequency counter 9 is controlled by a microcomputer 11 and outputs a count in the format of digital signals. The frequency counter 9 receives a start signal from the microcomputer 11 to start its counting operation and provides the microcomputer 11 with output data when the counting operation is terminated. An overflow detector 10, provided between the frequency counter 9 and the microcomputer 11, outputs an overflow signal to the microcomputer 11 when the counter 9 counts up a predetermined count.

Both the frequency counter 9 and the overflow detector 10 are reset responsively to each reset signal given from the microcomputer 11. The microcomputer 11 uses the outputs from both the frequency counter 9 and the overflow detector 10 in order to determine that the intermediate frequency signal is out of a predetermined frequency. That is, such determination is made responsively to the overflow signal continuously outputted over a certain range of frequencies when the frequency is equal to or more than a given amount, though, on the other hand, the intermediate frequency signal is merely counted below the given frequency.

Meanwhile, the oscillation frequency of the laser fluctuates depending on its bias current and temperature. The microcomputer 11 adjusts control signals provided to, via D/A converters 12 to 15, temperature control circuits 16 and 18 and/or bias current control circuits 17 and 19 so that a difference between the counted frequency from the frequency counter 9 and a target frequency is cancelled out. This adjustment permits the bias current and temperature of the FM laser 1 and local oscillating laser 2 to be controlled, respectively, resulting in that the output of the electric coupler 6, namely the intermediate frequency signal, is stabilized.

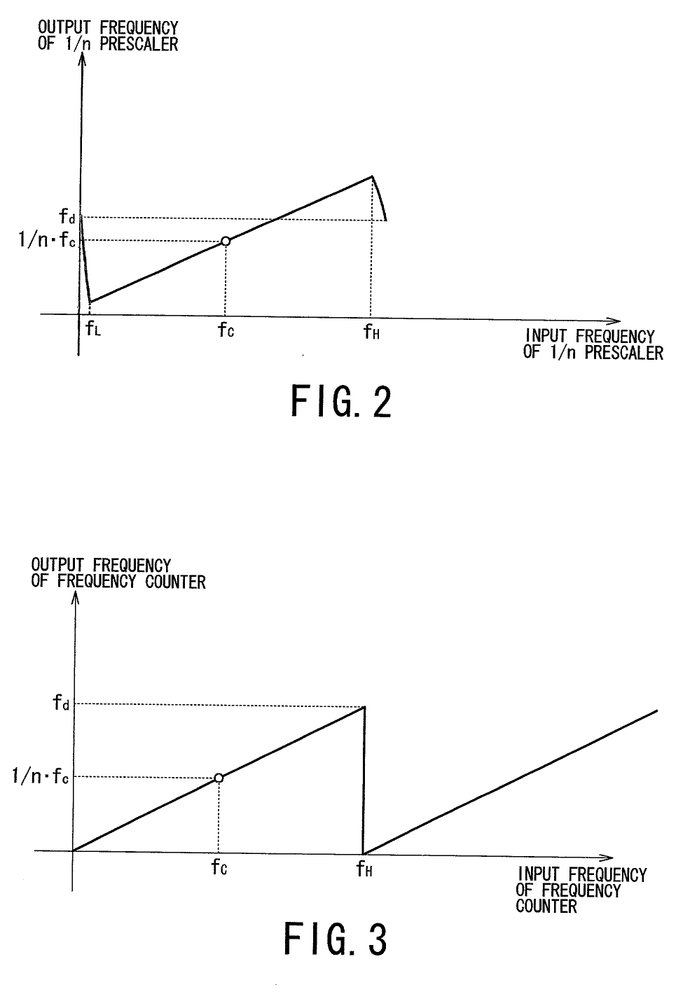

Referring to FIGS. 2 and 3, characteristics of the prescaler 8 and frequency counter 9 will now be described in brief.

The operation bandwidths of the prescaler 8 and frequency counter 9 are limited. As shown in FIG. 2, within a frequency of “f_{L}<f<f_{H}” for a normal operation, the prescaler divides the frequency f of an input signal on a specified division ratio and outputs the divided-frequency signal. In contrast, when the frequency f of an input signal is near zero [Hz] (less than f_{L}) or over a higher limit (over f_{H}), a certain amount of frequency f_{d} is outputted.

As shown in Fig.3, the frequency counter 9 returns its count to zero when the frequency reaches its upper limit f_{H} specified by the number of bits and restart the counting from zero [Hz]. In the similar way to this, the operations of other components located before the prescaler 8 may be limited by the frequency.

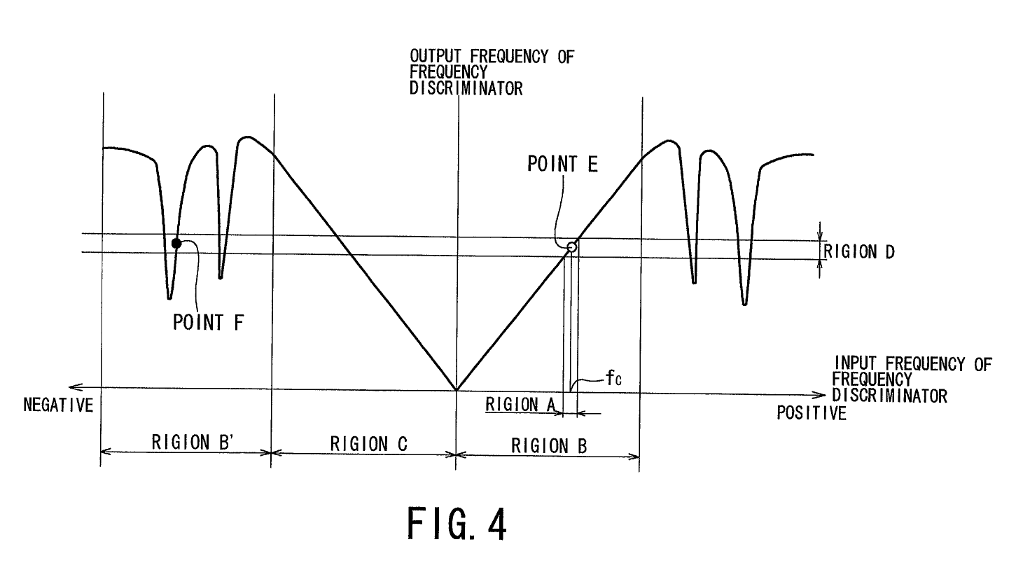

Considering the foregoing frequency characteristics, the output frequency of the frequency counter 9 to the output frequency of the optical receiver 4 (that is, the input frequency of the frequency counter 9) is shown in FIG. 4. In the figure, linear characteristics are given in the frequency bands irrelevant to the output of the overflow signal, while the characteristic outside the above bands change irregularly due to connected components. The frequency given to the horizontal axis corresponds to a difference between the oscillated frequencies of the FM laser 1 and local oscillating laser 2. A positive region of the characteristic is assigned to the situation where the FM laser 1 is larger in oscillation frequency than the local oscillating laser 2.

When considering that (1) the intermediate frequency to the controlled temperature and/or bias current changes oppositely between the positive and negative regions shown in FIG. 4 when the temperature and/or bias current of the FM laser 1 are controlled to stabilize the intermediate frequency and (2) components located before the frequency counter 9 have limitations in their frequency bands, normally controlling the intermediate frequency stabilization requires the intermediate frequency to be pulled previously in a region B shown in FIG. 4.

In this embodiment, the temperature or bias current of the FM laser 1 is swept for pulling the frequency.

The overflow detector 10 shown in FIG. 1 is configured, as descried above, such that it outputs the overflow signal whenever the intermediate frequency is, in the absolute value, over an arbitrarily set upper limit of frequencies of the regions B and C in FIG. 4. That is, the overflow signal continues to be outputted if the intermediate frequency falls into the given outside regions. Accordingly, the microcomputer 11 is able to determine if the intermediate frequency is in the given outside regions or not. With sweeping the temperature or bias current of the FM laser 1, the microcomputer 11 is able to pull the frequency into a stable operation point for automatic intermediate frequency stabilization control. To be specific, the frequency count is read during the non-output of the overflow signal in the predetermined region, as the temperature or bias current of the FM laser 1 is swept. According to the read count, the temperature or bias current is set so that the intermediate frequency falls into a region (a region A shown in FIG. 4) near to a target frequency in the condition that the rate of changes of the frequency to the temperature or bias current is positive. Thus, the frequency is pulled into a stable operation point for the automatic intermediate frequency stabilization control.

In the first embodiment, as described above, there is provided the circuitry to output an overflow signal in frequencies exceeds an arbitrary amount. This prevents malfunctions of components located before the frequency counter in regions outside a given frequency region. Accordingly the intermediate frequency can be pulled, with precision, into a stable operation point for the automatic intermediate frequency stabilization control, so that the AFC is started in a stable fashion.

Second Embodiment

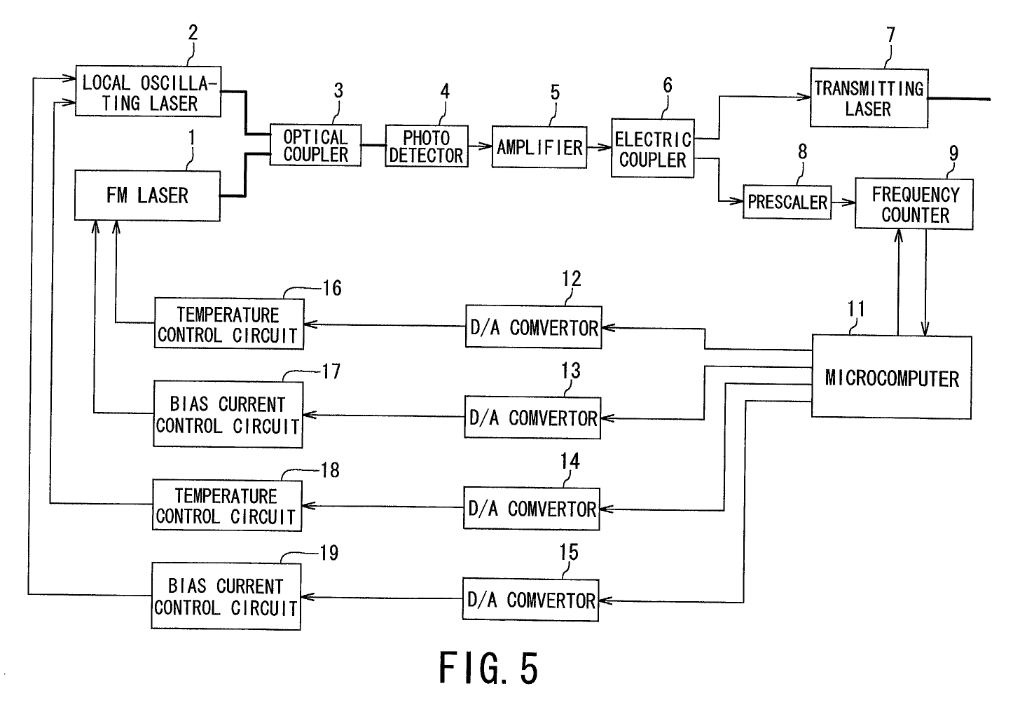

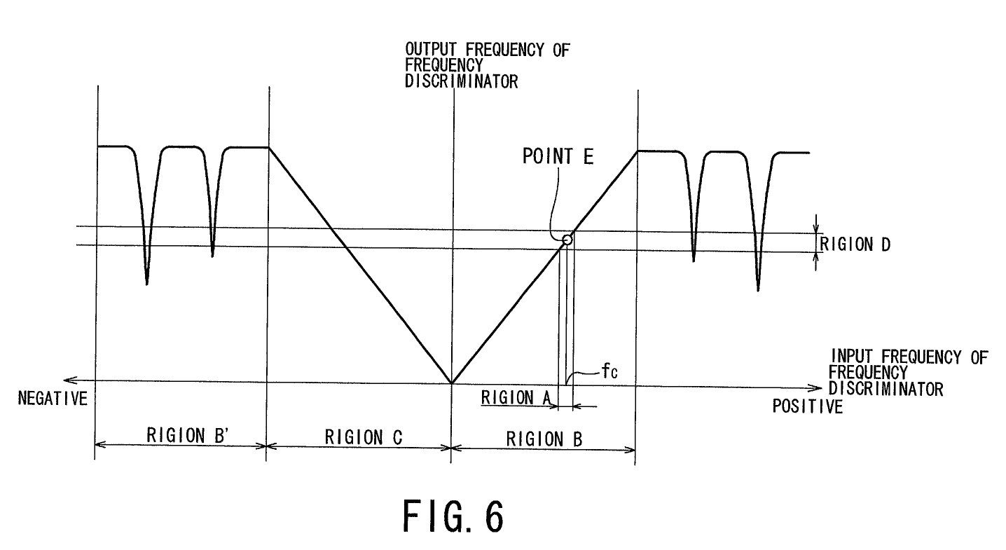

Referring to FIGS. 5 and 6, a second embodiment will now be described.

FIG. 5 shows a block diagram of the configuration of an optical signal transmitter of heterodyne detection type, in which the automatic frequency stabilization control circuit of the present invention is applied to the transmitter used as part of an optical signal transmission system.

As shown in FIG. 5, the optical signal transmitter according to the second embodiment differs from that shown in the first embodiment in that the overflow detector 10 shown in FIG. 1 is removed. The remaining hardware configurations and their operations are identical or similar to those described in the first embodiment, so their detailed explanation is omitted hereafter.

In this second embodiment, the frequency counter 9 is configured so that it holds the count at an arbitrarily set upper limit (absolute value) of frequencies in the regions B and C shown in FIG. 4. Therefore, frequencies read out by the microcomputer 11 change as shown in FIG. 6. In the case that the temperature or bias current is swept at a constant speed along one direction, assume that a gradient of the intermediate frequencies to the temperature or bias current is larger than a certain value within a continuous period of time. If it is determined that such gradient exists in the region B in FIG. 4, setting the temperature or bias current at a value corresponding to a region near to a target frequency (the region A in FIG. 4) within the region B enables the intermediate frequency to be pulled into a stable operation point for the automatic stabilization control.

As described above, the second embodiment of the present invention provides an additional function that counting the frequency is conducted in a frequency range below a given frequency, but the counting is held at its maximum. This prevents malfunctions of components located before the frequency discriminator in the regions outside a given frequency region. Accordingly, with the construction simplified, the intermediate frequency can steadily be pulled into a stable operation point for the automatic intermediate frequency stabilization control, so that the AFC is started in a stable and reliable fashion.

Third Embodiment

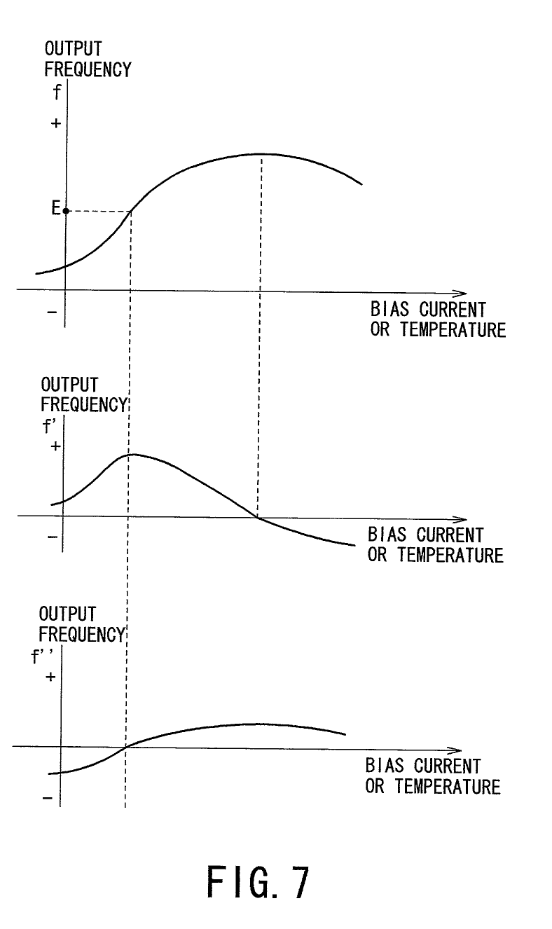

Referring to FIG. 7, together with FIGS. 4 and 5, a third embodiment will now be described.

An optical signal transmitter of heterodyne detection type according to the third embodiment, which is configured in the similar manner to the transmitter of FIG. 5, has an automatic intermediate frequency stabilization control apparatus according to the present invention. The control apparatus has the prescaler 8 and the frequency counter 9 functioning as a frequency discriminator, which have been described before. The prescaler 8 divides the frequency of the input signal within a range of operation frequencies of the frequency counter 9, and its divided output signal is supplied to the frequency counter 9. The frequency counter 9 counts the divided output signal, and then supplies its digital-form count to the microcomputer 11.

Referring to FIG. 4, the frequency characteristic relating to both the prescaler 8 and the frequency counter 9 will be described again.

Both of the prescaler 8 and the frequency counter 9 have limitations in their frequency bandwidths. Within frequency bandwidths under which those units operate in normal conditions, as shown in regions B and C in FIG. 4, the output changes in linear to its input. But in the outsides of those frequency regions, the output frequency fluctuates with irregularities caused due to the limitations of the prescaler 8 and frequency counter 9. Accordingly, the normal operation of the automatic intermediate frequency stabilization control apparatus requires the bias current or temperatures of a laser to be swept at its cold start so that the intermediate frequency is pulled into the region A. Also, a target frequency point E residing in the region A should be distinguished from another point F of which output frequency is the same as the target frequency.

Practically, under the sweep, the microcomputer 11 memorizes the temperature or bias current of the laser and the output frequency of the frequency counter 9. Then, the microcomputer 11 detects a point of frequency satisfying the requirements that the frequency is at a target value, the primary differential value of the frequency to the bias current or temperature is within a certain range, and the secondary differential value is approximately zero, then sets the detected point as the target point E (refer to FIG. 7). Controlling the bias current or temperature to that corresponding to the target point enables the intermediate frequency to be pulled into a stable operation point for the AFC.

According to the third embodiment, the microcomputer 11 uses the primary and secondary differential values of the output frequency of the frequency counter 9 to the temperature or bias current under the sweep so as to determine a target point to pull the frequency. This enables the frequency to be pulled into the stable operation point for the AFC at any time, which ensures a steady start of the AFC.

As to the third embodiment, the processing carried out by the microcomputer 11 serving as control means provides some modifications as follows.

First Modification

In this modification, like the third embodiment, values of the temperature or bias current under the sweep and the output frequencies of the frequency counter (frequency discriminator) resultant from the sweep are memorized by the microcomputer 11. Then, the microcomputer 11 detects a point of frequency satisfying that the output frequency is at a target value, the primary differential value of the output frequency to the bias current or temperature is positive (or negative), and the secondary differential value is approximately zero, then sets the detected point as the target point E (refer to FIG. 7). Controlling the bias current or temperature to that corresponding to the target point enables the intermediate frequency to steadily be pulled into a stable operation point for the AFC.

According to the first modification, set is the condition that a primary differential value of the output frequency of the frequency counter to the temperature or bias current to be swept is positive (or negative). This causes the intermediate frequency to be pulled into a stable operation point for the AFC, without being affected by differences in the characteristics of individual lasers, so that the AFC can be started without failure.

Alternatively, setting the condition that the primary differential value of the output frequency to the bias current or temperature is positive (or negative) within a certain range of frequencies allows the intermediate frequency to be pulled into a stable operation point for the AFC more steadily.

Second Modification

In a second modification, the temperature or bias current of a laser is changed at random by the microcomputer 11. Under such random changes, the output frequency, temperature, and bias current are memorized. In the region in which the secondary differential value of the output frequency of the frequency counter (i.e., frequency discriminator) is approximately zero, detected is a point of frequency satisfying that the output frequency is at a target value and the primary differential value of the output frequency to the bias current or temperature is positive (or negative), then sets the detected point as the target point (refer to FIG. 7). Controlling the bias current or temperature to that corresponding to the target point makes it possible that the intermediate frequency is steadily pulled into a stable operation point for the AFC.

Thus, the technique of changing the temperature and bias current at random is adopted in this second modification, resulting in that the intermediate frequency can be pulled into a stable operation point for the AFC more faster from a wider range of frequencies for the start of the AFC.

Fourth Embodiment

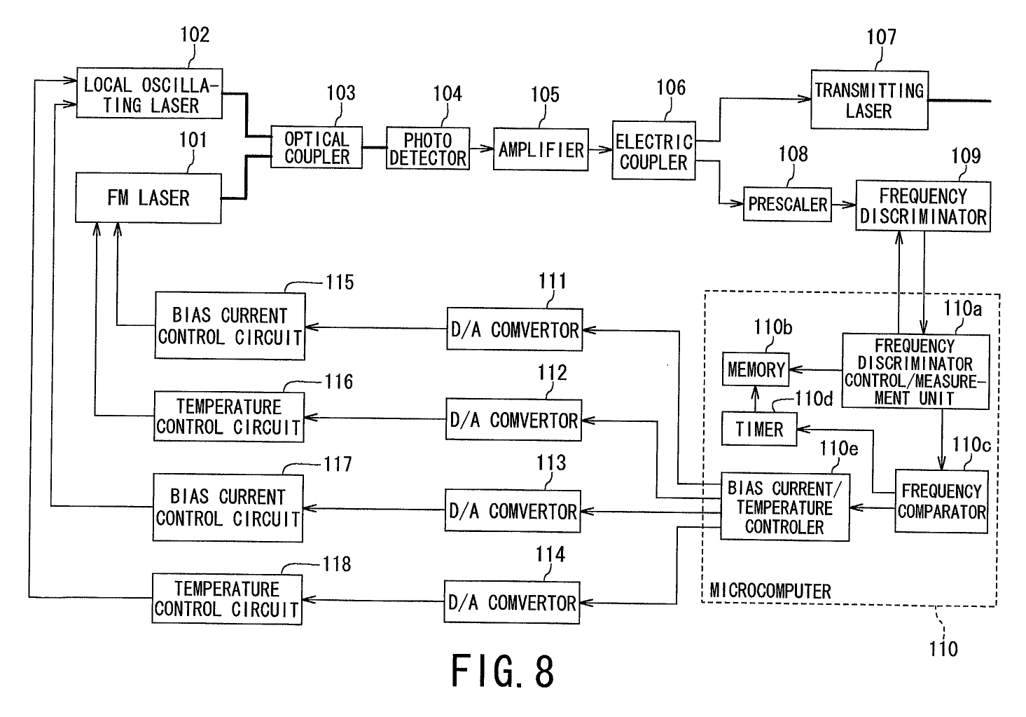

Referring to FIGS. 8 to 10, a fourth embodiment of the present invention will now be described.

FIG. 8 shows the configuration of an optical signal transmitter to which the automatic intermediate frequency stabilization control apparatus of the present invention is applied. In FIG. 8, thick signal lines indicate optical paths and thin signal lines indicate electric lines.

In the configuration shown in FIG. 8, an oscillation frequency of an FM laser 101 changes in response to bias current controlled by a bias current control circuit 115 and temperature controlled by a temperature control circuit 116. Also, an oscillation frequency of a local oscillating laser 102 changes in response to bias current controlled by a bias current control circuit 117 and temperature controlled by a temperature control circuit 118.

An FM laser beam outputted by the FM laser 101 and laser light outputted by the local oscillating laser 102 are combined by an optical coupler 103. The combined light is photoelectric-converted by an optical detector 104, thus being produced into a beat signal (intermediate frequency signal) of which frequency corresponds to a frequency difference between the FM laser beam and the locally oscillated laser beam. The beat signal is then amplified by an amplifier 105, before being into two signals by an electric coupler 106. One signal is fed to a transmitting laser 107, in which the signal is converted into an optical signal to be transmitted to a reception system.

The other output from the electric coupler 106 is fed to a prescaler 108, wherein the signal is divided within a range of operation frequencies of a frequency discriminator 109. The divided signal is supplied to the frequency discriminator 109. The frequency discriminator 9 counts up the divided intermediate signal and supplies a microcomputer 110 with its count. Software installed in the microcomputer 110 functionally realizes a frequency discriminator control/measurement unit 110a, frequency comparator 110c, timer 110d, and bias current/temperature controller 110e. The microcomputer 110 also includes a memory 110b.

The frequency discriminator 109 is a frequency counter to be controlled by the frequency discriminator control/measurement unit 110a of the microcomputer 110. The discriminator outputs a signal in digital amount. The frequency comparator 110c produces a signal of which frequency corresponding to a difference between a frequency (intermediate frequency) outputted from the frequency discriminator control/measurement unit 110a and a target frequency, then provides the bias current/temperature controller 110e with the produced signal. Since bias current and/or temperature are changed in each of the FM laser 101 and local oscillating laser 102, the oscillation frequency of each laser is changed as well. Accordingly, the AFC is conducted so that the output of the frequency comparator 110c is kept to zero through adjustment of the bias current and/or temperature.

Practically, in reply to the output of the frequency comparator 110c, the bias current/temperature controller 110e provides, via D/A converters 111 and/or 112, the bias current control circuit 115 and/or temperature control circuit 116 with changed values of bias current and/or changed value of temperature directed to the FM laser 101. In the same manner, the controller 110e provides, via D/A converters 113 and/or 114, the bias current control circuit 117 and/or temperature control circuit 118 with changed values of bias current and/or changed value of temperature directed to the local oscillating laser 102.

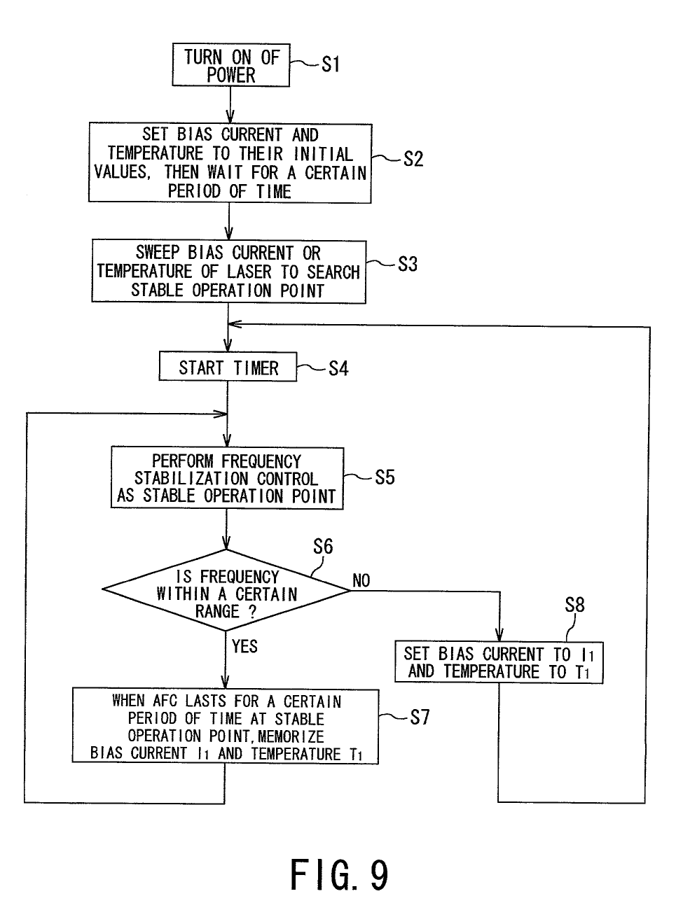

Referring to a flowchart shown in FIG. 9, a procedure to restart the AFC, which is performed by the microcomputer 110, will now be described in detail. When the intermediate frequency is brought into an uncontrollable state with the frequency departed from the region shown in FIG. 4 due to its sharp fluctuations, the AFC is restarted in a stable manner shown in FIG. 9, so that its stable operation point is kept within the region A shown in FIG. 4.

As shown in FIG. 9, when the power is turned on (step S1), the bias current and temperature of each of the lasers 101 and 102 are to set to their initial values and then a certain period of time is waited (step S2). Then, as the bias current or temperature is swept, a stable operation point, that is, the region A is searched based on, for example, the technique described in the foregoing embodiments (step S3).

In response to the fact that the frequency comparator 110c finds out that a difference between the intermediate frequency and the target frequency is smaller than a predetermined amount, the timer 110d is started (step S4). As long as the difference is below the predetermined amount, the AFC is continued at the foregoing stable operation point (steps S5 and S6). Under the AFC, when a certain period of time has passed after the start of operation of the timer 110d, a bias current I₁ and a temperature T₁ at that time are stored into the memory 110b (step S7).

That is, after the start of the AFC at the stable operation point, the bias current I₁ and the temperature T₁ for each laser at that time are gained. In cases the output of the frequency comparator 110c exceeds the certain amount during the frequency control because of various factors, such as sharp fluctuations of the bias current and/or temperature of the lasers 101 and/or 102 and fluctuations in the power source, the bias current and temperature of each of the lasers 101 and 102 are set to I₁ and T₁ (steps S6 and S8). This enables the AFC to be restarted in a stable manner. When a certain period of time has passed after the stabilization of the AFC, the values of the bias current and temperature for each laser are updated in the microcomputer 110 (steps S6 and S7).

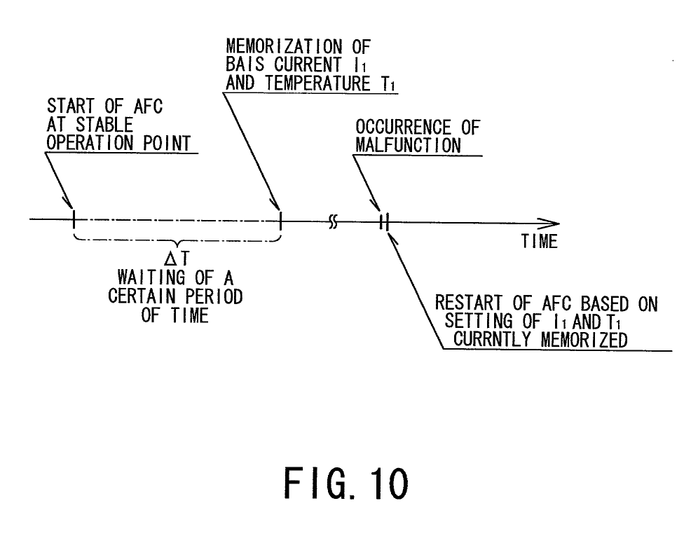

As shown in FIG. 10, in the fourth embodiment, the bias current I₁ and temperature T₁ for each laser are memorized just when a certain period of time (for example, 10 msec.) has passed after the start of the AFC at the stable operation point. In cases the AFC is brought into a malfunction state, the bias current and temperature for each of the lasers 101 and 102 are replaced by the memorized values of the bias current I1 and temperature T1, so that the AFC can be restarted with stability in a shorter time.

Fifth embodiment

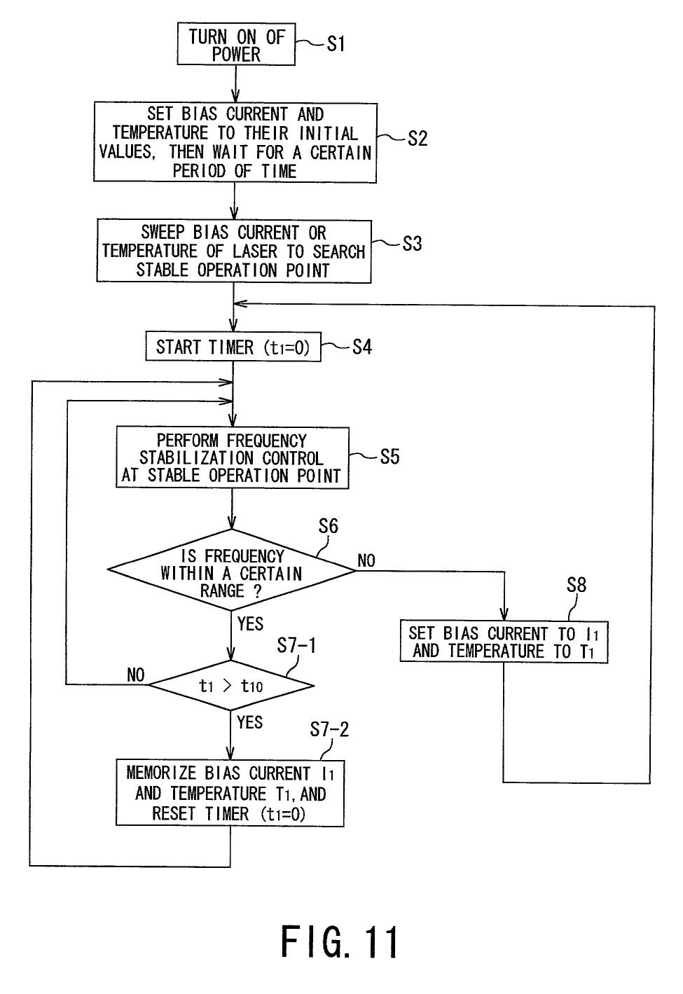

Referring to FIG. 11, a fifth embodiment of the present invention will now be described.

The configuration of circuitry of the apparatus according to the fifth embodiment is identical or similar to that shown in FIG. 8, so its detailed explanation is omitted (this omission is also true of a six embodiment and succeeding embodiments thereto).

FIG. 11 shows a series of procedures to restart a stable AFC when the intermediate frequency is brought into an uncontrollable state due to its sharp fluctuations.

The processing at steps S1 to S3, that is, the processing from turning on the power to pulling the frequency into the stable operation point is the same as those described in the forth embodiment (refer to FIG. 9), so its explanation is omitted. Only processing carried out after the AFC was disordered will be explained below.

When the AFC is started at a stable operation point, in response to the fact that the frequency comparator 110c finds out that a difference between the intermediate frequency and the target frequency is less than a predetermined amount, the timer 110d (timer's count t₁) is reset and started (step S4). As long as the difference is less than the predetermined amount, the AFC is continued at the foregoing stable operation point (steps S5 and S6).

In the case that the timer's count t₁, is less than a certain period of time tio (step S7-1), the processing is returned to step 5. By contrast, the timer's count t₁ reaches (i.e., detects) the certain period of time tio, the bias current I₁ and temperature T₁ for each laser are memorized by the memory 110b and the timer 110d is reset (steps S7-1 to S7-2). After this, whenever the timer's count t₁ reaches the certain period of time, the bias current I₁ and temperature T₁ in the memory 110b are updated.

That is, during the AFC at the stable operation point, the bias current I₁ and temperature T₁ are updated at intervals. But the output of the frequency comparator 110c becomes higher than a giver amount, the bias current is set to the memorized I₁ and the temperature to the memorized T₁, laser by laser (steps S6 and S8), which enables a stable restart of the AFC. Once the AFC is stabilized, the bias current and temperature held, laser by laser, by the microcomputer 110 are updated at intervals (steps S7-1 and S7-2).

In the fifth embodiment, the bias current and temperature are updated at intervals during the AFC at the stable operation point. And if the AFC has been out of order, the AFC is restarted on the basis of the regularly updated bias current and temperature. In consequence, the AFC can steadily be restarted in a stable manner.

Sixth Embodiment

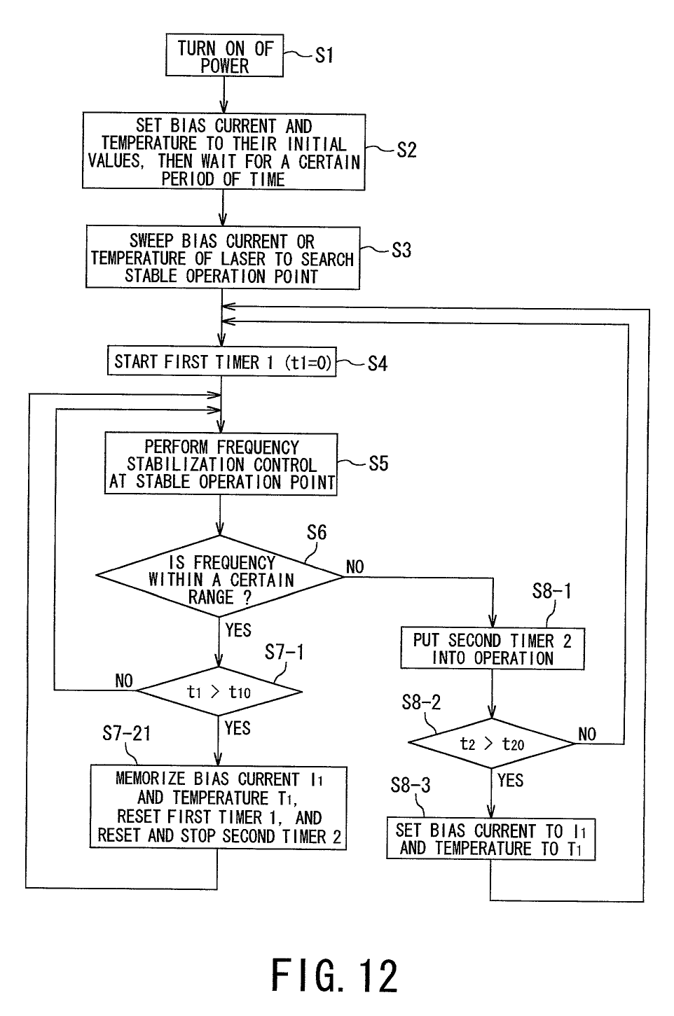

Referring to FIG. 12, a sixth embodiment of the present invention will now be described.

FIG. 12 shows a series of procedures to restart a stable AFC when the intermediate frequency is brought into an uncontrollable state due to its sharp fluctuations. The processing at steps S1 to S3 is the same as those described in FIG. 9.

When the AFC is started at a stable operation point, in response to the fact that the frequency comparator 110c finds out that a difference between the intermediate frequency and the target frequency is less than a predetermined amount, a first timer 1 (timer's count tᵢ) is reset (started) (step S4). As long as the difference is less than the predetermined amount, the AFC is continued at the foregoing stable operation point (steps S5 and S6).

Then, where it is determined at step S7-1 that the first timer's count t₁ is not larger than a predetermined constant time t₁₀, the processing is returned to step S5. But the condition of t₁>t₁₀ is established, a bias current I₁ and a temperature T₁ for each laser at that time are memorized in the memory 110b, the first timer 1 is reset, and a second timer 2 (timer's count t₂) that will be described later is reset and stopped (steps S7-1 and S7-21). The first and second timers 1 and 2 are functionally realized by the timer 110d. Every time when the first timer's count t₁ reaches the predetermined constant time t₁₀, the bias current I₁ and temperature T₁ are updated in the memory 110b.

In this embodiment, when the output of the frequency comparator 110c exceeds a certain amount during the frequency control, the foregoing second timer 2 is put into operation (step S8-1). Then, where it is determined at step S8-2 that the second timer's count t₂ is not larger than a predetermined constant time t₂₀ (>t₁₀), the processing is returned to step S4. But the condition of t₂>t₂₀ is established, the bias current and the temperature for each laser are set to I₁ and T₁ that have been memorized so far (step S8-3), before the processing is returned to step S4.

According to the sixth embodiment, if the state that the difference between the intermediate frequency and a target frequency is over a certain amount continues for the predetermined time t₂₀, the AFC is detected as being disordered. This avoids erroneous detecting malfunctions of the AFC.

Seventh Embodiment

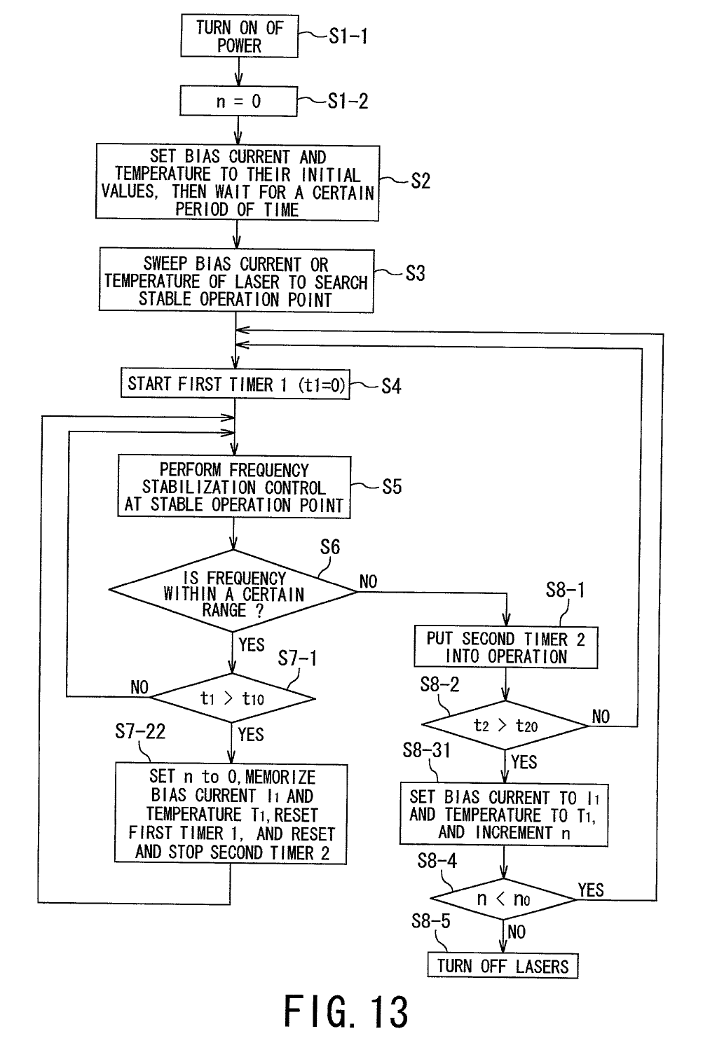

Referring to FIG. 13, a seventh embodiment of the present invention will now be described.

FIG. 13 shows a series of procedures carried out in the seventh embodiment. Specifically, when the step power source is turned on, the number (n) of times of restoration from an uncontrollable state of the apparatus is set to zero (steps S1-1 and S1-2). Then, the bias current and temperature of each of the lasers 101 and 102 are set to their initial values, then a certain time is waited (step S2). The bias current or temperature is then swept to search a stable operation point, i.e., the foregoing range A (step S3).

Before the AFC at the stable operation point is started, in response to the determination that the difference between the intermediate frequency and a target frequency is smaller than a certain amount, which is done by the frequency comparator 110c, a first time 1 (timer's count t₁) is reset and started (step S4). As long as such difference is less than the certain amount, the AFC is continued at the stable operation point (steps S5 and S6).

Then, the processing proceeds to determination at step S7-1, where if t₁>t₁₀ or not is determined. When the first timer's count ti is less than a certain time tio, the processing is returned to step S5. But the condition of t₁>t₁₀ is met, the number n of times of restoration is set to zero, a value of bias current I₁ and a value of temperature T₁ for each laser at that time are memorized into the memory 110b, the first timer 1 is reset, and a second timer 2 (timer's count t₂) is reset and stopped (steps S7-1 and S7-22). Then the processing goes back to step S4. After this, whenever the first timer's count t₁ reaches the certain time too, the bias current I₁ and temperature T₁ are updated into the memory 110b.

In the case that the output of the frequency comparator 110c exceeds a certain value during the AFC, the second timer 2 is put into operation (step S8-1). Then, when it is determined at step S8-2 that the second timer's count t₂ is less than or equal to a certain time t₂₀ (>t₁₀), the processing is returned to step S4. In contrast, the condition of t₂>t₂₀ is satisfied, the bias current and temperature for each laser are set to the values I₁ and T₁ that have been memorized at present and the number n of times of restoration is incremented (steps S8-2 and S8-31).

In the seventh embodiment, where it is determined at step S8-4 that the number n of times of restoration is smaller than its upper limit no, the processing goes back to step S4. On the other hand, the number n is equal to or over the upper limit no, the controller or laser(s) is regarded as disordered. So driving of the lasers 101 and 102 is stopped (step S8-5).

Therefore, during the AFC at the stable operation point, the bias current and the temperature to be memorized are updated at intervals. In cases the AFC is brought into a malfunction, the bias current and temperature are set to those memorized ones to restart the AFC. This makes it possible the AFC is restored to its stable one in a shorter time. In addition, limiting the number n of times of restoration to an infinite value prevents the restoration operation from being repeated endlessly, thus malfunctions of the lasers or others being found shortly.

Eighth Embodiment

In the foregoing fourth to seventh embodiments, when a malfunction of the AFC occurs, the bias current and temperature memorized at that time have been set to simply restart the AFC. However, there is a possibility that this way could not find a stable operation point after restarting the AFC. To secure such finding, the present embodiment adopts the technique that the bias current and temperature memorized so far are set, and then swept, when the malfunction of the AFC occurs.

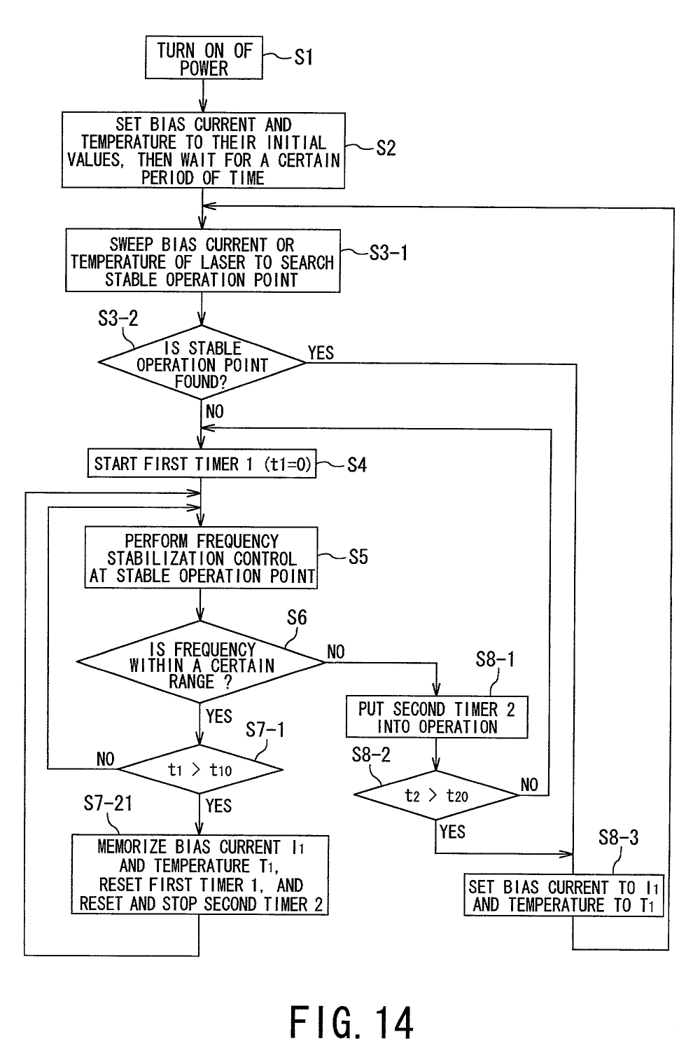

FIG. 14 shows a series of procedures carried out in the eighth embodiment, which is further modified from the processing shown in FIG. 12.

First, when the power is turned on, the bias current and temperature of each of the lasers 101 and 102 are set to their initial values, then a certain time is waited (steps S1 and S2). The bias current or temperature is then swept to search a stable operation point, i.e., the foregoing range A (step S3-1).

Then, it is determined whether the stable operation point has been found or not (step S3-2). If found, the processing is made to go to step S4, whilst, if not found, the processing goes to step S8-3 at which the bias current and temperature are set to values I₁ and T₁ memorized in the memory 110b at that time. Then, the processing is returned to step S3-1, at which the bias current or temperature is swept in such a manner that the stable operation point (i.e., the range A) is searched again.

The processing at the remaining steps is the same as that in FIG. 12, so its explanation is omitted. Incidentally, where it is determined that the operation point is moved outside a given frequency range after the automatic frequency stabilization control has been started (step S5), the processing is returned to step S3-1 through steps S8-1, S8-2, and S8-3, so that the stable operation point is searched again.

As described above, in the eighth embodiment, when the AFC malfunctions, a sweep of either of the bias current or the temperature is performed using, as a central value for the sweep, a value thereof that have been memorized at intervals during the AFC carried out at a stable operation point. That is, the AFC is restarted at the re-searched stable operation point, resulting in that it is possible to return to a stable AFC with steadiness.

Ninth Embodiment

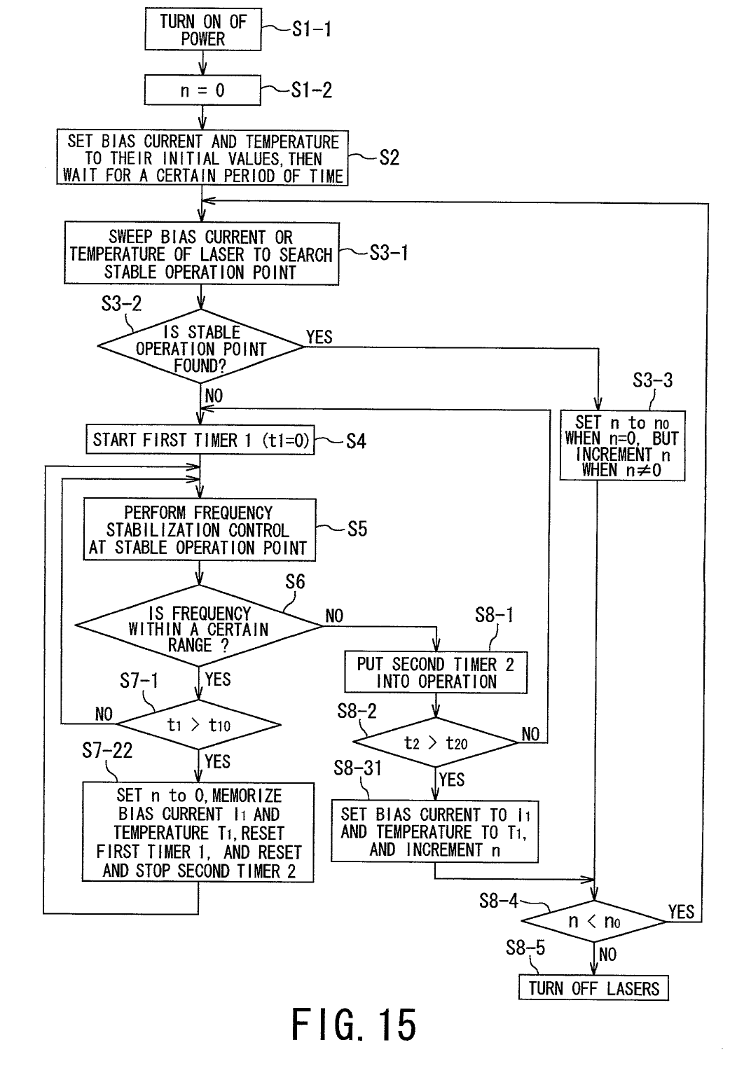

Referring to FIG. 15, a ninth embodiment of the present invention will now be described.

FIG. 15 indicates a processing technique of the ninth embodiment, in which the processing charts shown in FIGS. 13 and 14 are combined with each other.

Practically, at first, when the step power source is turned on, the number (n) of times of restoration from an uncontrollable state of the apparatus is set to zero (steps S1-1 and S1-2). Then, the bias current and temperature of each of the lasers 101 and 102 are set to their initial values, then a certain time is waited (step S2). The bias current or temperature is then swept to search a stable operation point, i.e., the foregoing range A (step S3-1). Then, it is determined whether the stable operation point has been found or not (step S3-2). If found, the processing goes to step S4.

However, if the stable operation point has not been found at the determination of step S3-2, the processing is routed to step S3-3, at which the number n of times of restoration is set to its upper limit no when the number n was zero, while the number n is incremented when the number n was not zero. The processing then proceeds to step S8-4, at which it is determined if n<n₀ or not. As a result, the determination is affirmative, that is, n<n₀ is realized, the processing is returned to step S3-1, while it is negative, the drive power such as the lasers is turned off (step S8-5). The remaining processing is the same as that shown in FIGS. 13 and 14, so detailed explanation is omitted.

According to the ninth embodiment, when the AFC malfunctions, a sweep is performed as to either the bias current or temperature that have been memorized at intervals during the AFC at the stable operation point, so that the stable operation point can be searched. That is, since the AFC is restarted at the re-searched stable operation point, it is possible to return to a stable AFC with more steadiness. In addition, limiting the number n of times of restoration to an infinite value prevents the restoration operation from being repeated endlessly, thus malfunctions of the lasers or others being found shortly.

Tenth Embodiment

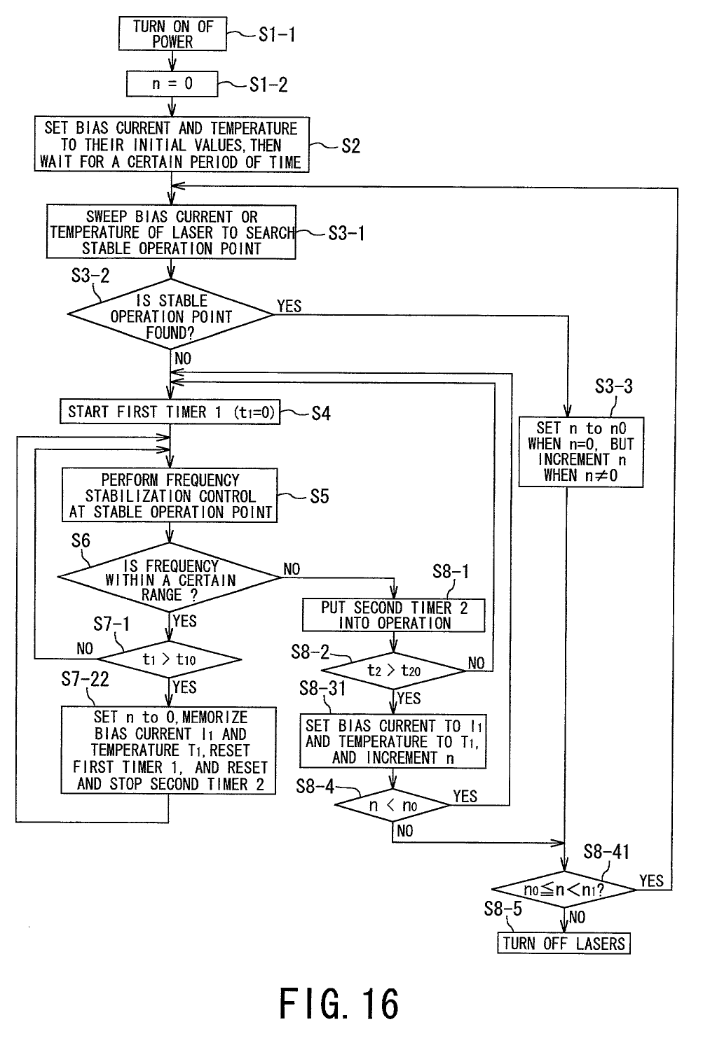

Referring to FIG. 16, a tenth embodiment of the present invention will now be described.

FIG. 16 represents the processing according to the tenth embodiment, which is modified from that described in the ninth embodiment.

Practically, as shown in FIG. 16, a step S8-41 is added betweenthe steps S8-4 and S8-5. If the determination of n<n₀ is made successfully at step S8-4, the processing is returned to step S4. But when the determination is not made so at step S8-4, it is then determined at step S8-41 whether a condition of n₀≦n<n₁ (each of n₀ and n₁ is a predetermined number of times; n₀<n₁) is established or not, without immediately turning off the drive power such as the lasers. If the condition of n₀≦n<n₁ is established, the processing is returned to step S3-1. In contrast, such condition is not established, the lasers 101 and 102 are turned off (step S8-5). The other steps are the same in processing as those in FIG. 15.

According to the tenth embodiment, the bias current and temperature are memorized at intervals during the AFC carried out at a stable operation point. When the AFC is brought into a malfunction, the bias current and temperature for each laser are returned to the memorized values at that time and the AFC is restarted. If the AFC is still out of order even when such restart has been made, the sweep of either the bias current or the temperature is done using, as a central value for the sweep, a memorized value thereof in such a manner that a stable operation point is searched. The searched stable operation point is used to restart the AFC. This makes it possible that the AFC returns to its stable one with steadiness in a shorter period of time depending on a fluctuated width of the intermediate frequency. In addition, limiting the number n of times of restoration to an infinite value prevents the restoration operation from being repeated endlessly, thus malfunctions of the lasers or others being found shortly.

Eleventh Embodiment

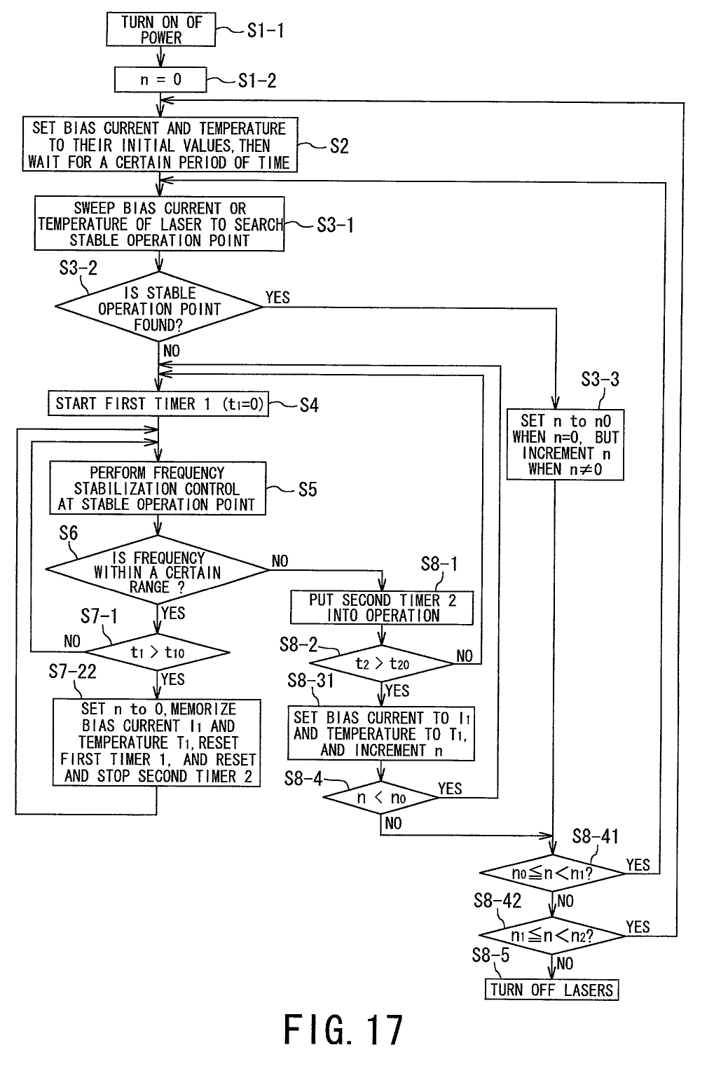

Referring to FIG. 17, an eleventh embodiment of the present invention will now be described.

FIG. 17 shows the processing performed in the eleventh embodiment. In this processing, a step S8-42 is additionally inserted between the steps S8-41 and S8-5 shown in FIG. 16. Namely, the determination of n₀≦n<n₁ is not realized at step S8-41, the drive power including the lasers will not be turned off immediately. It is additionally determined if n₁≦n<n₂ is true or not. When n₁≦n<n₂ is true, the processing is returned to step S2 to set the bias current and temperature to their initial values, as described before. The waiting is then done for a given period of time, which is followed by the sweep. On the other hand, the condition of n₁≦n<n₂ (n₂ is a predetermined number of times; n₁<n₂) is not realized, the drive power including the lasers are turned off (step S8-5). The remaining processing is the same as that in FIG. 16.

According to the eleventh embodiment, the bias current and temperature are memorized at intervals during the AFC carried out at a stable operation point. When the AFC malfunctions, the bias current and temperature for each laser are returned to the memorized values at that time, then the AFC is restarted. If the AFC is still out of order even when such restart has been made, the sweep of the bias current or temperature is done using, as a central value for the sweep, a previously memorized value thereof in such a manner that a stable operation point is searched. The searched stable operation point is used to restart the AFC. The AFC is still out of order after such restart, the procedure of setting initial values to the bias current and temperature is repeated, like the procedure of turning on the power. This makes it possible to return the AFC to its stable one with steadiness in a shorter period of time depending on a fluctuated width of the intermediate frequency. In addition, limiting the number n of times of restoration to an infinite value prevents the restoration operation from being repeated endlessly.

Twelfth Embodiment

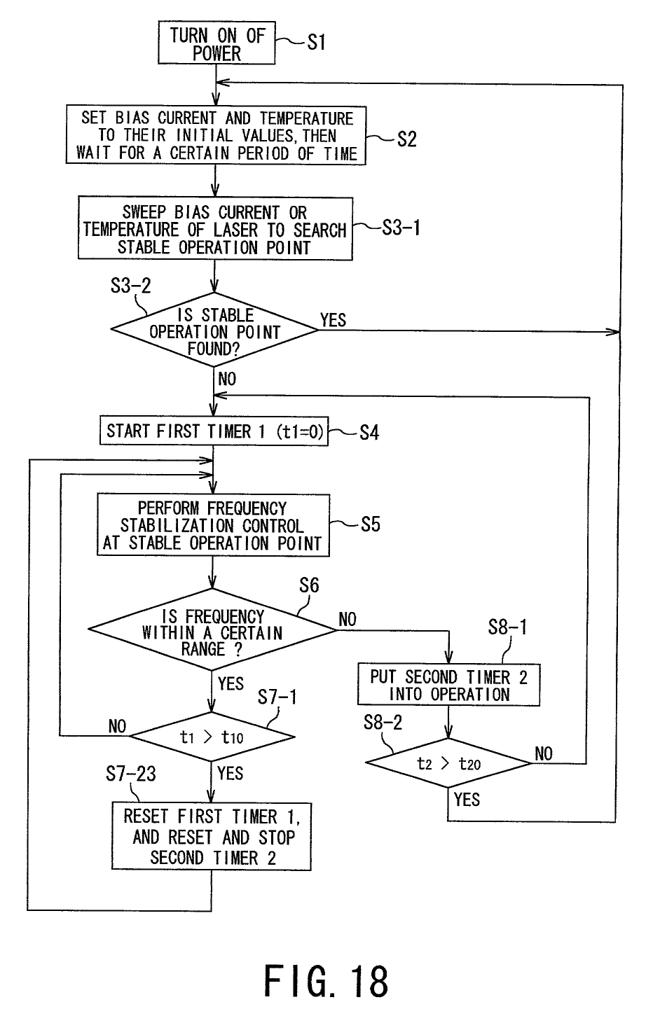

Referring to FIG. 18, a twelfth embodiment of the present invention will now be described.

FIG. 18 shows the processing to restart the AFC, which is performed in the twelfth embodiment.

First, the bias current and temperature of each of the lasers 101 and 102 are set to their initial values when the step power source is turned on, and then waiting is done for a certain period of time (steps S1 and S2). The bias current or temperature is then swept to search a stable operation point, that is, the region A (step S3-1). After this, it is determined if the stable operation point is found or not (step S3-2). When found, the processing is made to proceed to step S4, in contrast, when such stable operation point is not found, the processing is returned to step S2 to set the bias current and temperature to their initial values.

The processing at and after step S4 will now be described. When the AFC is started at the stable operation point, a first timer 1 (timer's count t₁) is reset and started in response to the fact that the frequency comparator 110c determined that a difference between the intermediate frequency and a target frequency is smaller than a predetermined amount (step S4). As long as such difference is kept smaller than the predetermined amount, the AFC at the stable operation point is continued (steps S5 and S6). Then, through the determination for t₁>t₁₀ at step S7-1 (t₁₀ is a given time), the processing is returned to step S5 if the condition of t₁>t₁₀ is not established. But such condition is established, the first timer 1 is reset and a second timer 2 (timer's count t₂) is reset and stopped (step S7-23). Then the processing is returned to step S5.

If the output of the frequency comparator 110c exceeds a certain amount during the AFC, the second timer 2 is activated (step S8-1). Then, through the determination for t₂>t₂₀ at step S8-2 (t₂₀ is a given time larger than t₁₀), the processing is retuned to step S4 unless the condition of t₂>t₂₀ is not realized. In contrast, such condition is realized, the processing goes back to step S2 where the bias current and temperature are set to their initial values.

In this twelfth embodiment, if there occurs a malfunction of the AFC, the procedures carried out when the power is turned on are repeated, thus being returned to a stable AFC. Unlike the foregoing various embodiments, it is unnecessary for the apparatus to memorize the bias current and temperature, simplifying the procedures for the AFC.

Thirteenth Embodiment

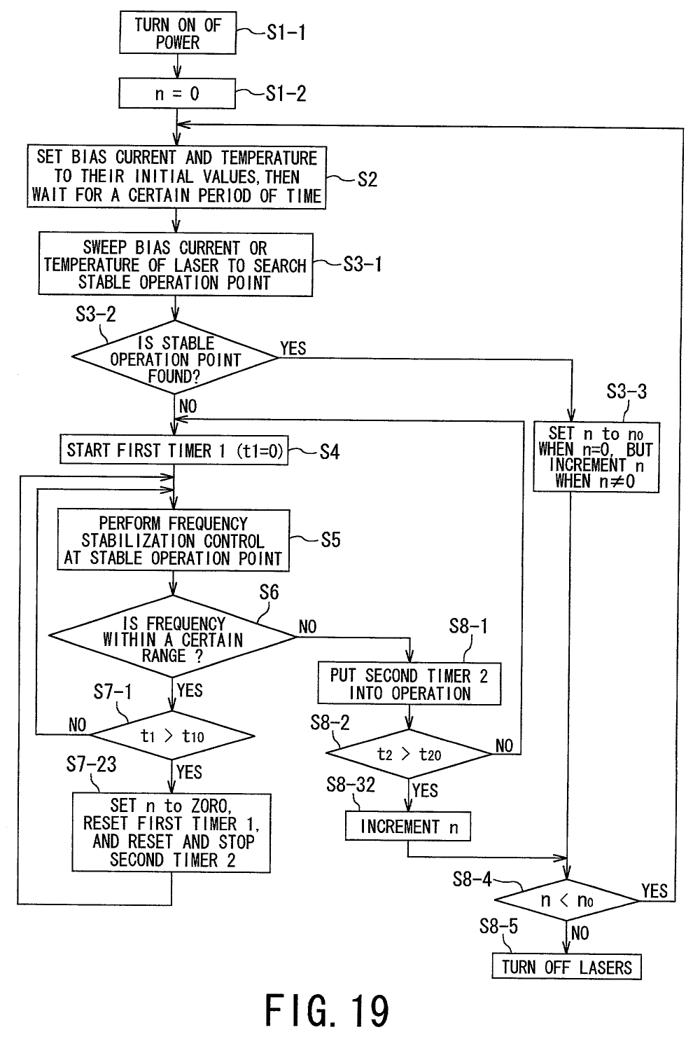

Referring to FIG. 19, a thirteenth embodiment of the present invention will now be described.

FIG. 19 shows the procedures to restart the AFC carried out in the thirteenth embodiment, which is modified from the twelfth embodiment. To be specific, the configuration described in the twelfth embodiment is combined with that in the ninth embodiment (refer to FIG. 15).

In this thirteenth embodiment, like the twelfth embodiment, the bias current and temperature are set to their initial values without involving storage of those data of the bias current and temperature, as shown at step S7-23 in FIG. 19. Instead, at step S7-23, the number (n) of times of restoration is set to zero, the first timer 1 is reset, and the second timer 2 is reset and stopped. Further, at step S8-32, the number n is incremented.

According to the thirteenth embodiment, like the twelfth embodiment, there is the advantage that the operation and processing to restart the AFC are simplified.

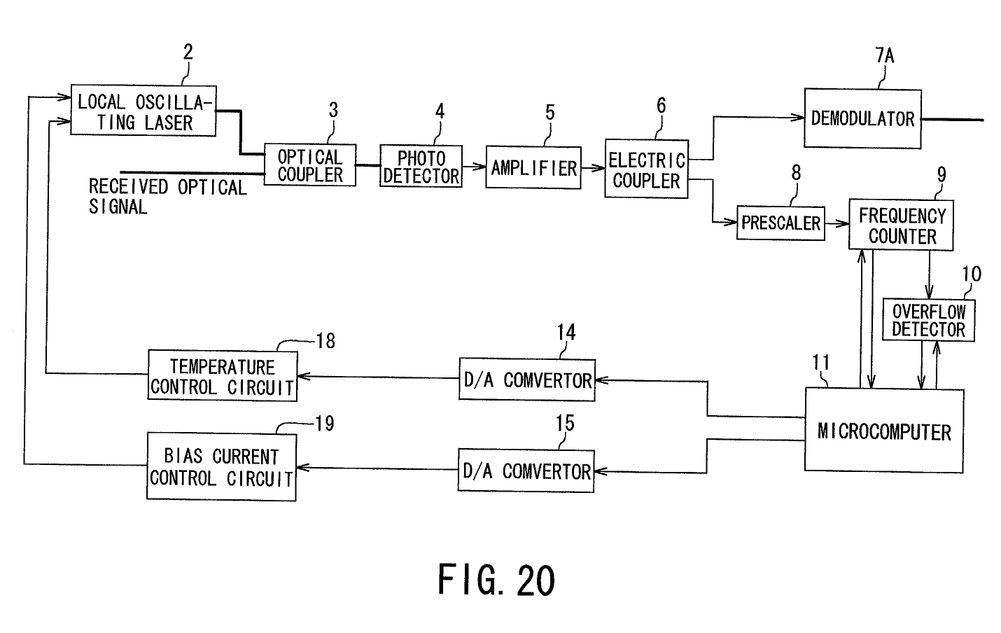

The foregoing various embodiments have been described about the optical signal transmitter employed as an object into which the control apparatus of the present invention is incorporated. In the case of the transmitter, both FM laser 101 and local oscillating laser 102 have been controlled. Alternatively, as shown in FIG. 20, the control apparatus of the present invention can be applied to an optical signal receiver, in which only the local oscillating laser 2 is controlled with the foregoing AFC techniques, so that the control circuits 16 and 17 and the D/A converters 12 and 13 shown in FIG. 1 are omitted. Further, the transmitting laser 7 shown in FIG. 7 is replaced by a demodulator 7A. By the similar way to the above, the configurations shown in FIGS. 5 and 8 can also be changed into optical signal receivers to which the control apparatus of the present application is applied.

Still, the present invention is not limited to the foregoing embodiments and their modifications, but, without departing from the gist of the present invention described in the appended claims, the present invention can be further modified and practiced in other various modes.

What is claimed is:

1. An automatic intermediate frequency stabilization control apparatus comprising:
intermediate frequency signal producing means for producing an intermediate frequency signal by combining light outputted from an FM laser with light outputted from a local oscillating laser and performing heterodyne detection with combined light, a difference between both oscillation frequencies of the light outputs corresponding to the intermediate frequency signal;
frequency discrimination means for discriminating in frequency the intermediate frequency signal for automatic intermediate frequency stabilization control;
detecting means for detecting a given state in which the intermediate frequency signal is over in frequency than a specified frequency; and
pulling control means for pulling the intermediate frequency signal into a stable operation point for the automatic intermediate frequency stabilization control when the detecting means detect the given state.

2. The automatic intermediate frequency stabilization control apparatus of claim 1, wherein the frequency discrimination means are a frequency counter receiving the intermediate frequency signal and the detecting means are overflow detecting means for outputting an overflow signal when a count of the frequency counter reaches the specified frequency.

3. The automatic intermediate frequency stabilization control apparatus of claim 2, further comprising an electric coupler to make a path of the intermediate frequency signal to a plurality of paths thereof and a prescaler to divide the intermediate frequency signal received through one of the paths up to an operation frequency of the frequency counter,
wherein the overflow detecting means is configured so as to output the overflow signal in cases the intermediate frequency signal reaches a frequency indicative of an outside frequency band higher than a frequency band of electric circuitry constituents located before the prescaler, the frequency corresponding to the given frequency.

4. The automatic intermediate frequency stabilization control apparatus of claim 1, wherein the frequency discrimination means are a frequency counter receiving the intermediate frequency signal and holding a count corresponding to the given frequency when the intermediate frequency signal is over the given frequency and the detecting means detect the given state when the frequency counter holds the count thereof.

5. An automatic intermediate frequency stabilization control apparatus comprising:
intermediate frequency signal producing means for producing an intermediate frequency signal by combining light outputted from an FM laser with light outputted from a local oscillating laser and performing heterodyne detection with combined light, a difference between both oscillation frequencies of the light outputs corresponding to the intermediate frequency signal;
frequency discrimination means for discriminating in frequency the intermediate frequency signal for automatic intermediate frequency stabilization control;
determining means for determining a stable operation point for the automatic intermediate frequency stabilization control on the basis of a frequency of an output signal of the frequency discrimination means and primary and secondary differential values of the output signal frequency to either of bias current and temperature of at least one of the lasers; and
controlling means for pulling the intermediate frequency signal into the stable operation point determined by the determining means.

6. The automatic intermediate frequency stabilization control apparatus of claim 5, wherein the determining means is configured so as to determine, as the stable operation point, a point of frequency satisfying a condition that the output signal frequency of the frequency discrimination means is at a target frequency, the primary differential value is within a predetermined range, and the secondary differential value is approximately zero.

7. The automatic intermediate frequency stabilization control apparatus of claim 5, wherein the determining means is configured so as to determine, as the stable operation point, a point of frequency satisfying a condition that the output signal frequency of the frequency discrimination means is at a target frequency, the primary differential value is either positive or negative, and the secondary differential value is approximately zero.

8. The automatic intermediate frequency stabilization control apparatus of claim 5, wherein the determining means is configured so as to determine, as the stable operation point, a point of frequency satisfying a condition that the output signal frequency of the frequency discrimination means is at a target frequency, the primary differential value is either positive or negative within a predetermined range, and the secondary differential value is approximately zero within a predetermined range.

9. The automatic intermediate frequency stabilization control apparatus of claim 5, wherein the determining means is configured so as to determine, as the stable operation point, a point of frequency satisfying a condition that the output signal frequency of the frequency discrimination means is at a target frequency and the primary differential value is either positive or negative within a predetermined range in a region where the secondary differential value is approximately zero within a predetermined range, the bias current or temperature being changed at random.

10. An automatic intermediate frequency stabilization control apparatus comprising:
intermediate frequency signal producing means for producing an intermediate frequency signal by combining light outputted from an FM laser with light outputted from a local oscillating laser and performing heterodyne detection with combined light, a difference between both oscillation frequencies of the light outputs corresponding to the intermediate frequency signal;
memorizing means for memorizing data of at least one of bias current and temperature of at least one of the FM laser and the local oscillating laser when a stabilized control state of the intermediate frequency signal continues for a certain time; and
restart control means for restart stabilized control of the intermediate frequency signal by controlling an oscillation signal of at least one of the FM laser and the local oscillating laser on the basis of at least the bias current and the temperature memorized in cases the intermediate frequency signal deviates from the stabilized control state.

11. The automatic intermediate frequency stabilization control apparatus of claim 10, wherein the stabilized control state of the intermediate frequency signal is a state in which a difference between the intermediate frequency and a target frequency is smaller than a given value.

12. The automatic intermediate frequency stabilization control apparatus of claim 11, further comprising detecting means for detecting a given state in which the intermediate frequency signal is a value residing in an outside of a specified frequency region; and pulling control means for pulling the intermediate frequency signal into a stable operation point for the automatic intermediate frequency stabilization control when the detecting means detect the given state.

13. The automatic intermediate frequency stabilization control apparatus of claim 11, wherein the memorizing means is configured so as to update the memorized data at intervals during the stabilized control state of the intermediate frequency signal.

14. The automatic intermediate frequency stabilization control apparatus of claim 11, wherein the restart control means is configured so as to restart the stabilization control in cases the intermediate frequency signal deviates from the stabilized control state after continuation of the stabilized control state for a given period of time.

15. The automatic intermediate frequency stabilization control apparatus of claim 11, wherein the restart control means has means for stopping the control unless the stabilized control state is obtained even when an action to start the automatic stabilization control is repeated a predetermined number of times.

16. The automatic intermediate frequency stabilization control apparatus of claim 12, wherein the restart control means has means for searching a stable operation point for the automatic stabilization control by sweeping either the bias current or the temperature using, as a central value for the search, data of either the bias current or the temperature memorized in the memorizing means in cases the intermediate frequency signal deviates from the stabilized control state.

17. The automatic intermediate frequency stabilization control apparatus of claim 12, wherein the restart control means has means for searching a stable operation point for the automatic stabilization control by sweeping either the bias current or the temperature using, as a central value for the search, data of either the bias current or the temperature memorized in the memorizing means unless a stabilized control state is found even when the automatic stabilization control is restarted.

18. The automatic intermediate frequency stabilization control apparatus of claim 12, wherein the restart control means has means for searching a stable operation point for the automatic stabilization control by sweeping either the bias current or the temperature using, as a central value for the search, data of either the bias current or the temperature memorized in the memorizing means unless the stabilized control state is found even when the stabilization control is restarted and means for stopping the automatic stabilization control unless the stabilized control state is realized even when the search of the stable operation point is repeated a predetermined number of times.

19. The automatic intermediate frequency stabilization control apparatus of claim 12, wherein the restart control means has means for repeating an action to restart the stabilization control up to a first predetermined number of times no, means for searching a stable operation point for the automatic stabilization control by sweeping the bias current or the temperature using, as a central value for the search, data of either the bias current or the temperature memorized in the memorizing means unless the stabilized control state is obtained through repeating the automatic stabilization control, and means for stopping the automatic stabilization control unless the stabilized control state is obtained through repeating the search a second predetermined number of times “n₁−n₀” (n₀<n₁).

20. The automatic intermediate frequency stabilization control apparatus of claim 12, wherein the restart control means has means for repeating an action to restart the stabilization control up to a first predetermined number of times n₀, means for searching a stable operation point for the automatic stabilization control by sweeping the bias current or the temperature using, as a central value for the search, data of either the bias current or the temperature memorized in the memorizing means unless the stabilized control state is obtained through repeating the automatic stabilization control, and means for setting at least one of the bias current and the temperature to initial values unless the stabilized control state is obtained through repeating the search a second predetermined number of times “n₁−n₀” (n₀<n₁), mean for performing a waiting action during a certain period of time after the setting of the initial values, means for searching the stable operation point by sweeping the bias current or the temperature after the waiting, and means for stopping the automatic stabilization control unless the stabilized control state is obtained through repeating the search a third predetermined number of times “n₂−n₁” (n₀<n₁<n₂).

21. An optical signal transmitter in which an automatic intermediate frequency stabilization control apparatus is incorporated, the automatic intermediate frequency stabilization control apparatus comprising:
intermediate frequency signal producing means for producing an intermediate frequency signal by combining light outputted from an FM laser with light outputted from a local oscillating laser and performing heterodyne detection with combined light, a difference between both oscillation frequencies of the light outputs corresponding to the intermediate frequency signal;
memorizing means for memorizing data of at least one of bias current and temperature of at least one of the FM laser and the local oscillating laser when a stabilized control state of the intermediate frequency signal continues for a certain time; and
restart control means for restart stabilized control of the intermediate frequency signal by controlling an oscillation signal of at least one of the FM laser and the local oscillating laser on the basis of at least the bias current and the temperature memorized in cases the intermediate frequency signal deviates from the stabilized control state.

22. An optical signal receiver in which an automatic intermediate frequency stabilization control apparatus is incorporated, the automatic intermediate frequency stabilization control apparatus comprising:
intermediate frequency signal producing means for producing an intermediate frequency signal by combining light outputted from an FM laser with light outputted from a local oscillating laser and performing heterodyne detection with combined light, a difference between both oscillation frequencies of the light outputs corresponding to the intermediate frequency signal;
memorizing means for memorizing data of at least one of bias current and temperature of at least one of the FM laser and the local oscillating laser when a stabilized control state of the intermediate frequency signal continues for a certain time; and
restart control means for restart stabilized control of the intermediate frequency signal by controlling an oscillation signal of at least one of the FM laser and the local oscillating laser on the basis of at least the bias current and the temperature memorized in cases the intermediate frequency signal deviates from the stabilized control state.

23. An automatic intermediate frequency stabilization control apparatus comprising:
intermediate frequency signal producing means for producing an intermediate frequency signal by combining light outputted from an FM laser with light outputted from a local oscillating laser and performing heterodyne detection with combined light, a difference between both oscillation frequencies of the light outputs corresponding to the intermediate frequency signal; and
control means for, in cases the intermediate frequency signal deviates from a stabilized control state thereof, setting to an initial value at least one of bias current and temperature of at least of the FM laser and the local oscillating laser, performing a waiting action for a certain period of time after setting the initial value, and searching a stable operation point for automatic stabilization control of the intermediate frequency signal by sweeping the bias current or the temperature after the waiting.

24. The automatic intermediate frequency stabilization control apparatus of claim 23, wherein the stabilized control state of the intermediate frequency signal is a state in which a difference between the intermediate frequency and a target frequency is smaller than a given value.

25. The automatic intermediate frequency stabilization control apparatus of claim 23, wherein the control means include means for setting at least one of the bias current and the temperature to initial values thereof, before searching the stable operation point, in cases the intermediate frequency signal deviates continuously from the stabilized control state for a certain period of time.

26. The automatic intermediate frequency stabilization control apparatus of claim 23, wherein the control means has means for setting at least one of the bias current and the temperature to initial values thereof, performing a waiting action of a certain period of time after the setting of the initial values, and searching a stable operation point by sweeping the bias current or the temperature after the waiting, in cases the intermediate frequency signal deviates continuously from a stabilized control state for a certain period of time, and means for stopping the automatic stabilization control unless the stabilized control state is obtained even when the search is repeated a predetermined number of times.

27. An optical signal transmitter in which an automatic intermediate frequency stabilization control apparatus is incorporated, the automatic intermediate frequency stabilization control apparatus comprising:
intermediate frequency signal producing means for producing an intermediate frequency signal by combining light outputted from an FM laser with light outputted from a local oscillating laser and performing heterodyne detection with combined light, a difference between both oscillation frequencies of the light outputs corresponding to the intermediate frequency signal; and
control means for, in cases the intermediate frequency signal deviates from a stabilized control state thereof, setting to an initial value at least one of bias current and temperature of at least of the FM laser and the local oscillating laser, performing a waiting action for a certain period of time after setting the initial value, and searching a stable operation point for automatic stabilization control of the intermediate frequency signal by sweeping the bias current or the temperature after the waiting.

28. An optical signal receiver in which an automatic intermediate frequency stabilization control apparatus is incorporated, the automatic intermediate frequency stabilization control apparatus comprising:
intermediate frequency signal producing means for producing an intermediate frequency signal by combining light outputted from an FM laser with light outputted from a local oscillating laser and performing heterodyne detection with combined light, a difference between both oscillation frequencies of the light outputs corresponding to the intermediate frequency signal; and
control means for, in cases the intermediate frequency signal deviates from a stabilized control state thereof, setting to an initial value at least one of bias current and temperature of at least of the FM laser and the local oscillating laser, performing a waiting action for a certain period of time after setting the initial value, and searching a stable operation point for automatic stabilization control of the intermediate frequency signal by sweeping the bias current or the temperature after the waiting.

29. A method for controlling an intermediate frequency in a stabilized control state, comprising the steps of:
producing means for producing an intermediate frequency signal by combining light outputted from an FM laser with light outputted from a local oscillating laser and performing heterodyne detection with combined light, a difference between both oscillation frequencies of the light outputs corresponding to the intermediate frequency signal;
discriminating in frequency the intermediate frequency signal for automatic intermediate frequency stabilization control;
detecting a given state in which the intermediate frequency signal is over in frequency than a specified frequency; and
pulling the intermediate frequency signal into a stable operation point for the automatic intermediate frequency stabilization control when the detecting means detect the given state.

30. A method for controlling an intermediate frequency in a stabilized control state, comprising the steps of:
producing means for producing an intermediate frequency signal by combining light outputted from an FM laser with light outputted from a local oscillating laser and performing heterodyne detection with combined light, a difference between both oscillation frequencies of the light outputs corresponding to the intermediate frequency signal; and
in cases the intermediate frequency signal deviates from a stabilized control state thereof, setting to an initial value at least one of bias current and temperature of at least of the FM laser and the local oscillating laser, performing a waiting action for a certain period of time after setting the initial value, and searching a stable operation point for automatic stabilization control of the intermediate frequency signal by sweeping the bias current or the temperature after the waiting.

31. A method for controlling an intermediate frequency in a stabilized control state, comprising the steps of:
producing means for producing an intermediate frequency signal by combining light outputted from an FM laser with light outputted from a local oscillating laser and performing heterodyne detection with combined light, a difference between both oscillation frequencies of the light outputs corresponding to the intermediate frequency signal; and
on the basis of memorized data of at least one of bias current and temperature of at leas one of the FM laser and the local oscillating laser memorized when the stabilized control state of the intermediate frequency signal continues for a certain time, restarting stabilized control of the intermediate frequency signal by controlling an oscillation signal of at least one of the FM laser and the local oscillating laser on the basis of at least the bias current and the temperature in cases the intermediate frequency signal deviates from the stabilized control state.

32. The method of claim 31, wherein the stabilized control state of the intermediate frequency signal is a state in which a difference between the intermediate frequency and a target frequency is smaller than a given value.

33. The method of claim 32, further comprising the steps of detecting a given state in which the intermediate frequency signal is over in frequency than a specified frequency; and pulling the intermediate frequency signal into a stable operation point for the automatic intermediate frequency stabilization control when the given state is detected.

34. The method of claim 32, wherein the memorized data are updated at intervals during the stabilized control state of the intermediate frequency signal.

35. The method of claim 32, wherein the automatic stabilization control is restarted in cases the intermediate frequency signal deviates from the stabilized control state after continuation of the stabilized control state for a given period of time.

36. The method of claim 32, wherein the control is stopped unless the stabilized control state is obtained even when an action to start the automatic stabilization control is repeated a predetermined number of times.

37. The method of claim 32, wherein a stable operation point for the automatic stabilization control is searched by sweeping either the bias current or the temperature using, as a central value for the search, data of either the bias current or the temperature memorized in cases the intermediate frequency signal deviates from the stabilized control state.

38. The method of claim 32, wherein a stable operation point for the automatic stabilization control is searched by sweeping either the bias current or the temperature using, as a central value for the search, data of either the bias current or the temperature memorized unless the stable operation point is found even when the stabilization control is restarted.

39. The method of claim 32, wherein a stable operation point for the automatic stabilization control is searched by sweeping either the bias current or the temperature using, as a central value for the search, data of either the bias current or the temperature memorized unless the stable operation point is found even when the stabilization control is restarted and the automatic stabilization control is stopped even when the search of the stable operation point is repeated a predetermined number of times.
